(19) United States
(12) Patent Application Publication
(10) Pub. No.: US 2026/0036704 A1
(43) Pub. Date: Feb. 5, 2026

(54) DIRECT X-RAY DETECTORS BASED ON ORGANIC METAL HALIDE HYBRIDS

(71) Applicant: The Florida State University Research Foundation, Inc., Tallahassee, FL (US)

(72) Inventors: Oluwadara Joshua Olasupo, Tallahassee, FL (US); Biwu Ma, Tallahassee, FL (US)

(21) Appl. No.: 19/284,849

(22) Filed: Jul. 30, 2025

Related U.S. Application Data
(60) Provisional application No. 63/677,634, filed on Jul. 31, 2024.

(51) Int. Cl. G01T 1/24

(52) U.S. Cl. CPC G01T 1/244

(57) ABSTRACT

Disclosed herein are direct X-ray detectors based on organic metal halide hybrids (OMHHs). For example, described herein are direct X-ray detectors including an organic metal halide hybrid (OMHH) material and a first and a second electrode. In some examples, the OMHH has a composition of RₖMₗXₘ, wherein R is a semiconducting organic cation, M is a metal chosen from Zn, Cu, Mn, Pb, Sn, Sb, and Bi, and X is a halide chosen from Cl, Br, I, and combinations thereof, and wherein k, l, and m are integers.

### CROSS-REFERENCE TO RELATED APPLICATIONS

This application claims the benefit of priority to U.S. Provisional Application No. 63/677,634 filed Jul. 31, 2024, which is hereby incorporated herein by reference in its entirety.

### STATEMENT OF GOVERNMENT SUPPORT

This invention was made with government support under DMR-2204466 awarded by the National Science Foundation. The government has certain rights in the invention.

### BACKGROUND

Direct X-ray detectors are devices that directly convert X-ray photons into electrical signals without the need for an intermediate conversion step. These detectors are crucial components in X-ray machines used for diagnostic imaging, security screening, and industrial inspection. Most of commercially available direct X-ray detectors are based on inorganic semiconductors, such as silicon and selenium, which show low sensitivity, spatial resolution, and image quality. However, there are many disadvantages of inorganic semiconductors based direct X-ray detectors, including cost, bulkiness, temperature sensitivity, radiation damage, and energy dependency.

Conventional direct X-ray detectors are based on silicon and selenium and can be costly to manufacture and maintain, which may limit their widespread adoption, particularly in smaller healthcare facilities or resource-limited settings. In other technical areas, solution-based processing of device components reduces manufacturing costs and increase their adoption.

Semiconductor-based X-ray detectors can be bulky and heavy, which may limit their portability and case of handling, especially in clinical environments where mobility and space are limited.

Silicon and selenium-based X-ray detectors can be sensitive to temperature variations, which may affect their performance and stability over time. Fluctuations in temperature can lead to changes in detector sensitivity and image quality.

Prolonged exposure to X-rays can cause radiation damage to the semiconductor materials used in these detectors, leading to degradation of detector performance over time. This degradation may manifest as increased noise levels, reduced sensitivity, or pixel defects, affecting image quality and diagnostic accuracy.

The sensitivity of direct X-ray detectors based on silicon and selenium to X-ray photons may vary depending on the energy spectrum of the incident radiation. Calibration and correction procedures may be necessary to ensure consistent image quality across different X-ray energy ranges.

Direct X-ray detectors that convert radiations to electrical charges and thus digital images have wide applications, ranging from medical diagnostics to security screening and industrial inspection. The most commonly used materials to construct direct X-ray detectors are inorganic semiconductors, such as silicon and selenium, which however suffer from limited performance, versatility, and cost-effectiveness. Searching for new-generation materials for direct X-ray detectors has been continually pursued to address these issues and expand their applications in various fields.

### SUMMARY

In accordance with the purposes of the disclosed devices, methods, and systems as embodied and broadly described herein, the disclosed subject matter relates to direct X-ray detectors based on organic metal halide hybrids (OMHHs).

Disclosed herein are highly efficient and stable direct X-ray detectors based on a new class of hybrid materials, zero-dimensional (0D) organic metal halide hybrids (OMHHs), which contain metal halide species as X-ray absorber and organic semiconducting components as charge transporter. With molecular sensitization, the rationally designed semiconducting 0D OMHHs are sought to replace conventional inorganic semiconductors for high performance, low cost direct X-ray detectors.

In some examples, the techniques described herein relate to a direct X-ray detector including an organic metal halide hybrid (OMHH) material and a first and a second electrode.

In some examples, the OMHH has a composition of RₖMₗXₘ, wherein R is a semiconducting organic cation, M is a metal chosen from Zn, Cu, Mn, Pb, Sn, Sb, and Bi, and X is a halide chosen from Cl, Br, I, and combinations thereof, and wherein k, l, and m are integers.

In some examples, the OMHH has a composition of (R)₂MX₄, (R)₂M₂X₄, or (R)₄M₄X₁₆.

In some examples, the OMHH has a composition of (R)₂MX₄.

In some examples, the semiconducting organic cation of the OMHH is a charge transporter.

In some examples, an organic moiety of the OMHH comprises a 4-(4-(diphenylamino)phenyl)-1-propylpyridin-1-ium (TPA-P⁺).

In some examples, a metal halide of the OMHH is an X-ray absorber.

In some examples, a metal halide of the OMHH comprises Zn, Cu, Bi, and a halide, wherein the halide is one of Br, Cl, I, or combinations thereof.

In some examples, a metal halide of the OMHH comprises Zn and a halide, wherein the halide is one of Br, Cl, I, or combinations thereof.

In some examples, the OMHH material comprises (TPA-P)₂ZnX₄, (TPA-P)₂Cu₂X₄, or (TPA-P)₄Bi₄X₁₆.

In some examples, the OMHH material comprises (TPA-P)₂ZnBr₄, (TPA-P)₂Zn₁₄, (TPA-P)₂Cu₂I₄, or (TPA-P)₄Bi₄I₁₆.

In some examples, the OMHH material comprises (TPA-P)₂ZnX₄.

In some examples, the OMHH material comprises (TPA-P)₂ZnBr₄.

In some examples, the OMHH material is zero-dimensional.

In some examples, the OMHH material is a single crystal.

In some examples, the OMHH material is produced by solution-based processing.

In some examples, the OMHH material is produced by low-temperature processing.

In some examples, the first and the second electrode comprise Au, Ag, indium tin oxide (ITO), carbon nanotubes (CNT), Cu, Ni, Al, etc., or combinations thereof.

In some examples, the first and the second electrode comprise Au, Ag, indium tin oxide (ITO), or combinations thereof.

In some examples, the direct X-ray detector has a working area of 0.8 by 0.8 mm². In some examples, the direct X-ray detector has a bias-dependent photoconductivity of 5.67×10⁻⁴ cm²·V⁻¹. In some examples, the direct X-ray detector has a sensitivity of at least 681 μC Gyₐᵢᵣ⁻¹cm⁻² at 5 V, of at least 1,352 μC Gyₐᵢᵣ⁻¹cm⁻² at 10 V, and of at least 2,292 μC Gyₐᵢᵣ⁻¹cm⁻² at 20 V. In some examples, the direct X-ray detector has a limit of detection of 37.5 nGyₐᵢᵣs⁻¹ at 20 V, wherein the limit of detection comprises a dose rate at a signal-to-noise ratio (SNR) of around 3. In some examples, the direct X-ray detector exhibits stable performance at a total dosage of at least 15, 440 mGyₐᵢᵣ of X-ray at 20V over 24 hours. In some examples, the direct X-ray detector exhibits stable X-ray-induced current when exposed to 178.7 μGyₐᵢᵣs⁻¹ dose rate applied at 20 second intervals for more than 580 continuous cycles.

Additional advantages of the disclosed devices, systems, and methods will be set forth in part in the description which follows, and in part will be obvious from the description. The advantages of the disclosed devices, systems, and methods will be realized and attained by means of the elements and combinations particularly pointed out in the appended claims. It is to be understood that both the foregoing general description and the following detailed description are exemplary and explanatory only and are not restrictive of the disclosed systems and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1A-FIG. 1D. Material design concept, growth, and characterization of 0D (TPA-P)₂ZnBr₄ single crystals. FIG. 1A, Schematic diagram of the molecular sensitization of 0D (TPA-P)₂ZnBr₄, where ZnBr₄²⁻ serves as the main X-ray high molecular weight absorber and TPA-P⁺ serves as the charge transporter to aid electron-hole separation. FIG. 1B, Schematic illustration of the slow room temperature evaporation method of a precursor solution made of 2:1 molar ratio of TPA-PBr and ZnBr₂, respectively, to grow large crystals of 0D (TPA-P)₂ZnBr₄ (Created with BioRender.com). FIG. 1C, Top and side views of a 0D (TPA-P)₂ZnBr₄ single crystal. FIG. 1D, Powder X-ray diffraction patterns of 0D (TPA-P)₂ZnBr₄ showing well-matched peaks with simulation results.

FIG. 2A-FIG. 2D. Photophysical and electronic characterizations of 0D (TPA-P)₂ZnBr₄. FIG. 2A, Ultraviolet-visible solid-state absorptance spectrum of 0D (TPA-P)₂ZnBr₄ with an estimated bandgap of 2.19 eV shown in the inset. FIG. 2B, I-V plot showing the dark resistivity of a 1.2 mm thick 0D (TPA-P)₂ZnBr₄crystal in a vertical device shown in the inset. FIG. 2C, Dark I-V curve fitting under the space charge-limited current (SCLC) model. FIG. 2D, Bias-dependent photoconductivity of a 0D (TPA-P)₂ZnBr₄ -based detector under continuous X-ray irradiation.

FIG. 3A-FIG. 3D. X-ray detection performance of 0D (TPA-P)₂ZnBr₄ device. FIG. 3A, Calculated X-ray absorption coefficients versus photon energy for 0D (TPA-P)₂ZnBr₄ compared to α-Se, Si, and a few reported 0D OMHHs. FIG. 3B, X-ray attenuation efficiency of the different detectors under 10.3 keV X-ray energy versus required detector thickness. FIG. 3C, Dark current versus time plots compared for both 3D CsPbBr₃ and 0D (TPA-P)₂ZnBr₄ detectors with insets of both devices. FIG. 3D, I-V plot showing X-ray detection results of 0D (TPA-P)₂ZnBr₄ at 20 V from dark to X-ray dose rate of 121.7 μGyₐᵢᵣ s⁻¹.

FIG. 4A-FIG. 4D. Extended X-ray detection performance and long-term operational stability test of 0D (TPA-P)₂ZnBr₄ device. FIG. 4A, X-ray current density as a function of dose rate under different applied bias voltages. FIG. 4B, X-ray sensitivity of 0D (TPA-P)₂ZnBr₄ detector as a function of different bias voltages. FIG. 4C, Signal-to-noise ratio (SNR) of 0D (TPA-P)₂ZnBr₄ detector obtained by measuring the X-ray current signals and the standard deviation of the respective X-ray currents measured at various dose rates. The detection limit of 37.5 nGyₐᵢᵣ s⁻¹ at 20 V corresponds to the signal at an SNR of 3.36. FIG. 4D, 580 complete on-off cycles response of the detector performed under an X-ray dose of 178.7 μGyₐᵢᵣ s⁻¹ at 20 V (on time: 20 s, off time: 20 s).

FIG. 5. Synthesis of (TPA-P)ZnBr₄ single crystals in dimethylformamide using room temperature solvent evaporation method (Created with BioRender.com).

FIG. 6. Cyclic voltammogram of TPA-PBr showing the oxidation and reduction of TPA-PBr alongside their respective electrochemical peaks.

FIG. 7. Ultra-violet visible solid-state absorption spectrum of TPA-PBr with an estimated bandgap shown in the inset.

FIG. 8. Frequency-dependent capacitance plot of 0D (TPA-P)₂ZnBr₄ capacitor with device architecture Au/(TPA-P)₂ZnBr₄/Au.

FIG. 9A-FIG. 9B. I-V plot showing X-ray detection results of 0D (TPA-P)₂ZnBr₄ from dark to 121.7 μGyₐᵢᵣs⁻¹ (FIG. 9A) at 5 V and (FIG. 9B) at 10 V.

FIG. 10. Plot of long-term operational stability of all data points taken for 0D (TPA-P)₂ZnBr₄ detector under continuous X-ray dose of 178.7 μGyₐᵢᵣs⁻¹ at 20 V for 24 hours.

FIG. 11. X-ray tube power versus dose rate taken at different voltages and currents to calibrate our MOXTEX X-ray source.

FIG. 12. Direct X-Ray detectors based on a eco-friendly semiconducting zero-dimensional organic zinc bromide hybrid.

FIG. 13. Thermogravimetric analysis (TGA) plot of 0D (TPA-P)₂ZnBr₄ single crystals for thermal stability test.

FIG. 14A. X-ray detection sensitivity plot of 0D (TPA-P)₂ZnBr₄ single crystal detector retested after 6 months at 20 V.

FIG. 14B. Comparison of X-ray detection sensitivity of the detector after 6 months.

FIG. 15. Image of 0D (TPA-P)₂Zn₁₄ single crystals (left panel) and the single crystal structure (right panel).

FIG. 16. Image of 0D (TPA-P)₂Cu₂I₄ single crystals (left panel) and the single crystal structure (right panel).

FIG. 17. Image of 0D (TPA-P)₄Bi₄I₁₆ single crystals (left panel) and the single crystal structure (right panel).

FIG. 18. UV-Vis solid-state absorptance spectrum of 0D (TPA-P)₄Bi₄I₁₆ with an estimated bandgap of 1.70 eV.

FIG. 19. Calculated X-ray absorption coefficients versus photon energy for 0D (TPA-P)₂ZnBr₄, 0D (TPA-P)₂Cu₂I₄, and (TPA-P)₄Bi₄I₁₆, compared to α-Se and Si.

FIG. 20. X-ray attenuation efficiency of 0D (TPA-P)₂ZnBr₄, 0D (TPA-P)₂Cu₂I₄, and (TPA-P)₄Bi₄I₁₆, compared to α-Se and Si, under 10.3 keV X-ray energy versus thickness.

FIG. 21. I-V Plot of 0D (TPA-P)₄Bi₄I₁₆ single crystal-based device in the dark.

FIG. 22. I-V Plots of 0D (TPA-P)₄Bi₄I₁₆ single crystal-based device under X-rays.

### DETAILED DESCRIPTION

The devices, methods, and systems described herein may be understood more readily by reference to the following detailed description of specific aspects of the disclosed subject matter and the Examples included therein.

Before the present devices, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps. As used in the specification and in the claims, the term “comprising” can include the aspects “consisting of” and “consisting essentially of.”

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Values can be expressed herein as an “average” value. “Average” generally refers to the statistical mean value.

By “substantially” is meant within 5%, e.g., within 4%, 3%, 2%, or 1%.

“Exemplary” means “an example of” and is not intended to convey an indication of a preferred or ideal embodiment. “Such as” is not used in a restrictive sense, but for explanatory purposes.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such ratio regardless of whether additional components are contained in the mixture.

A weight percent (wt. %) of a component, unless specifically stated to the contrary, is based on the total weight of the formulation or composition in which the component is included.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein the term “plurality” means 2 or more (e.g., 3 or more; 4 or more; 5 or more; 10 or more; 15 or more; 20 or more; 25 or more; 30 or more; 40 or more; 50 or more; 75 or more; 100 or more; 150 or more; 200 or more; 250 or more; 300 or more; 400 or more; 500 or more; 750 or more; 1000 or more; 1500 or more; 2000 or more; 2500 or more; 3000 or more; 4000 or more; or 5000 or more).

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used.

In view of the described processes and compositions, hereinbelow are described certain more particularly described aspects of the inventions. These particularly recited aspects should not, however, be interpreted to have any limiting effect on any different claims containing different or more general teachings described herein, or that the “particular” aspects are somehow limited in some way other than the inherent meanings of the language and formulas literally used therein.

### X-Ray Detectors and Methods of Making and Use Thereof

Disclosed herein is a direct X-ray detector including a zero-dimensional (0D) organic metal halide hybrid (OMHH) material and a first and a second electrode.

In some examples, the OMHH has a composition of:

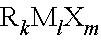

wherein:
R is a semiconducting organic cation,
M is a metal chosen from Zn, Cu, Mn, Pb, Sn, Sb, and Bi, and
X is a halide chosen from Cl, Br, I, and combinations thereof, and
wherein k, l, and m are integers.

In some examples, M is a metal chosen from Zn, Cu, and Bi. In some example, M is Zn.

In some examples, X is Br or I. In some example X is Br.

In some examples, M is a metal chosen from Zn, Cu, and Bi, and X is Br or I.

In some examples, k is 2 or 4.

In some examples, 1 is 1, 2, or 4.

In some examples, m is 4 or 16.

In some examples, k is 2 or 4; 1 is 1, 2, or 4; and m is 4 or 16, as valency permits.

In some examples, M is a metal chosen from Zn, Cu, and Bi; k is 2 or 4; 1 is 1, 2, or 4; and m is 4 or 16, as valency permits.

In some examples, M is a metal chosen from Zn, Cu, and Bi, X is Br or I; k is 2 or 4; 1 is 1, 2, or 4; and m is 4 or 16, as valency permits.

In some examples, the OMHH has a composition of (R)₂MX₄, (R)₂M₂X₄, or (R)₄M₄X₁₆. In some examples, the OMHH has a composition of (R)₂MX₄, (R)₂M₂X₄, or (R)₄M₄X₁₆, and M is a metal chosen from Zn, Cu, and Bi. In some examples, the OMHH has a composition of (R)₂MX₄, (R)₂M₂X₄, or (R)₄M₄X₁₆, and X is Br or I. In some examples, the OMHH has a composition of (R)₂MX₄, (R)₂M₂X₄, or (R)₄M₄X₁₆, M is a metal chosen from Zn, Cu, and Bi, and X is Br or I. In some examples, the OMHH has a composition of (R)₂MX₄, (R)₂M₂X₄, or (R)₄M₄X₁₆, and R is 4-(4-(diphenylamino) phenyl)-1-propylpyridin-1-ium (TPA-P⁺). In some examples, the OMHH has a composition of (R)₂MX₄, (R)₂M₂X₄, or (R)₄M₄X₁₆, R is 4-(4-(diphenylamino)phenyl)-1-propylpyridin-1-ium (TPA-P⁺), and M is a metal chosen from Zn, Cu, and Bi. In some examples, the OMHH has a composition of (R)₂MX₄, (R)₂M₂X₄, or (R)₄M₄X₁₆, R is 4-(4-(diphenylamino) phenyl)-1-propylpyridin-1-ium (TPA-P⁺), and X is Br or I. In some examples, the OMHH has a composition of (R)₂MX₄, (R)₂M₂X₄, or (R)₄M₄X₁₆, R is 4-(4-(diphenylamino)phenyl)-1-propylpyridin-1-ium (TPA-P⁺), M is a metal chosen from Zn, Cu, and Bi, and X is Br or I.

In some examples, the OMHH material comprises (TPA-P)₂ZnX₄, (TPA-P)₂Cu₂X₄, or (TPA-P)₄Bi₄X₁₆. In some examples, the OMHH material comprises (TPA-P)₂ZnX₄, (TPA-P)₂Cu₂X₄, or (TPA-P)₄Bi₄X₁₆, where X is Br or I.

In some examples, the OMHH material comprises (TPA-P)₂ZnBr₄, (TPA-P)₂Zn₁₄, (TPA-P)₂Cu₂I₄, or (TPA-P)₄Bi₄I₁₆. In some examples, the OMHH material comprises (TPA-P)₂ZnBr₄.

In some examples, the metal halide of the OMHH is an X-ray absorber.

In some examples, the metal halide of the OMHH comprises Zn, Cu, Bi, and a halide, wherein the halide is one of Br, Cl, I, or combinations thereof.

In some examples, the metal halide of the OMHH includes Zn and a halide, wherein the halide is one of Br, Cl, I, or combinations thereof. In some examples, the metal halide includes ZnBr₄, ZnCl₄, ZnI₄.

In some examples, the organic moiety of the OMHH is a charge transporter. In some examples, the organic moiety of the OMHH includes an organic cation. In some examples, the organic moiety is an extended conjugated system. In some examples, the extended conjugated system includes two or more independently aromatic moieties, wherein the aromatic moieties are chosen from aryl-substituted tertiary amine and pyridine. Each of the aromatic moieties may be singly or multiply substituted. The aromatic moieties may be connected 0 or more carbon-containing alkene, so as to form a conjugated system. For example, the organic moiety is 4-(4-(diphenylamino)phenyl)-1-propylpyridin-1-ium (TPA-P⁺).

In some examples, the OMHH is a 0D organic-inorganic hybrid material, for example 4-(4-(diphenylamino) phenyl)-1-(Propyl)-pyrindin-lium zinc halide ((TPA-P)₂ZnX₄). In some examples, the OMHH is (TPA-P)₂ZnBr₄.

In some examples, the OMHH material is zero-dimensional. In some examples, the OMHH material is a single crystal. In some examples, the OMHH is produced by solution-based processing. In some examples, the OMHH is produced by low-temperature processing.

The first electrode and second electrode can each independently comprise any suitable material consistent with the detectors described herein. For example, the first electrode and the second electrode can each independently comprise Au, Ag, indium tin oxide (ITO), carbon nanotubes (CNT), Cu, Ni, Al, etc., or a combination thereof. In some examples, the first and the second electrodes include Au, Ag, indium tin oxide (ITO), or combinations thereof. For example, the first and second electrode are Au; the first and second electrode are Ag; the first electrode is Au and the second electrode is ITO; the first electrode is Ag and the second electrode is ITO.

In some examples, the direct X-ray detector has a working area of 0.8 by 0.8 mm² or similar, depending on the size dimensions of the material.

In some examples, a direct X-ray detector having a working area of 0.8 by 0.8 mm² has a bias-dependent photoconductivity of 5.67×10⁻⁴ cm²·V⁻¹.

In some examples, a direct X-ray detector having a working arca of 0.8 by 0.8 mm² has a sensitivity of at least 681 μC Gyₐᵢᵣ⁻¹cm⁻² at 5 V, of at least 1,352 μC Gyₐᵢᵣ⁻¹cm⁻² at 10 V, and of at least 2,292 μC Gyₐᵢᵣ⁻¹cm⁻² at 20 V.

In some examples, a direct X-ray detector having a working area of 0.8 by 0.8 mm² has a limit of detection of 37.5 nGyₐᵢᵣs⁻¹ at 20V, wherein the limit of detection includes a dose rate at a signal-to-noise ratio (SNR) of 3.

In some examples, a direct X-ray detector having a working area of 0.8 by 0.8 mm² exhibits stable performance at a total dosage of at least 15,440 mGyₐᵢᵣ of X-ray at 20V over 24 hours.

In some examples, a direct X-ray detector having a working area of 0.8 by 0.8 mm² exhibits stable X-ray-induced current when exposed to 178.7 μGyₐᵢᵣs⁻¹ dose rate applied at 20 second intervals for more than 580 continuous cycles.

The disclosed 0D OMHHs based direct X-ray detectors offer several advantages over existing technologies, including high sensitivity, fast response time, tunability, flexibility and conformability, low-cost fabrication, low-temperature processing, and environmental friendliness.

For example, OMHHs exhibit high sensitivity to X-ray photons, owing to the high X-ray absorption coefficients of metal halides. This high sensitivity enables the detection of low-intensity X-ray signals, resulting in enhanced image quality and diagnostic accuracy.

For example, organic semiconducting components in OMHHs have fast carrier transport properties, leading to rapid response times to X-ray photons. This fast response time allows for quick image acquisition, making them suitable for real-time imaging applications such as fluoroscopy and dynamic radiography.

For example, OMHHs can be chemically engineered to have specific optical and electrical properties, including suitable bandgap, high charge carrier mobility lifetime product, and high defect tolerance. This tunability allows for customization of the detector's characteristics to match the requirements of the imaging application, leading to optimized performance.

For example, OMHHs have the potential to offer flexibility and conformability, enabling the fabrication of detectors on flexible substrates. This flexibility allows for the development of lightweight and wearable X-ray detectors, expanding their potential applications in wearable healthcare devices and point-of-care diagnostics.

For example, OMHHs can be processed using solution-based techniques, such as spin-coating or inkjet printing, on flexible and inexpensive substrates. This low-cost fabrication method reduces manufacturing expenses and makes large-scale production feasible, contributing to the commercial viability of the detectors.

For example, OMHHs can be processed at relatively low temperatures compared to conventional semiconductors, reducing energy consumption and production costs. This low-temperature processing also enables compatibility with flexible and lightweight substrates, expanding the range of potential applications.

For example, OMHHs typically exhibit environmentally friendly properties, as they can be synthesized from Earth-abundant and non-toxic elements. This environmental friendliness is advantageous for sustainable manufacturing practices and disposal at the end of the device's lifecycle.

Overall, the OMHHs-based direct X-ray detectors offer significant advantages in terms of sensitivity, response time, tunability, flexibility, low-cost fabrication, low-temperature processing, and environmental friendliness, making them promising candidates for advanced imaging technologies in medical and industrial fields.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1—Direct X-Ray Detectors Based on Organic Metal Halide Hybrids

Direct X-ray detectors that convert radiations to electrical charges and thus digital images have wide applications, ranging from medical diagnostics to security screening and industrial inspection. The most commonly used materials to construct direct X-ray detectors are inorganic semiconductors, such as silicon and selenium, which however suffer from limited performance, versatility, and cost-effectiveness. Searching for new-generation materials for direct X-ray detectors has been continually pursued to address these issues and expand their applications in various fields. Herein, highly efficient and stable direct X-ray detectors based on a new class of hybrid materials, zero-dimensional (0D) organic metal halide hybrids (OMHHs) have been developed for the first time, which contain metal halide species as X-ray absorber and organic semiconducting components as charge transporter. With molecular sensitization, the rationally designed semiconducting 0D OMHHs have the potential to replace conventional inorganic semiconductors for high performance low cost direct X-ray detectors.

Direct X-ray detectors are devices that directly convert X-ray photons into electrical signals without the need for an intermediate conversion step. These detectors are important components in X-ray machines used for diagnostic imaging, security screening, and industrial inspection. Most of commercially available direct X-ray detectors are based on inorganic semiconductors, such as silicon and selenium, which show high sensitivity, spatial resolution, and image quality. However, there are many disadvantages of inorganic semiconductors based direct X-ray detectors, including, but not limited to:
1) Cost: Direct X-ray detectors based on silicon and selenium can be costly to manufacture and maintain, which may limit their widespread adoption, particularly in smaller healthcare facilities or resource-limited settings.
2) Bulkiness: These detectors can be bulky and heavy, which may limit their portability and case of handling, especially in clinical environments where mobility and space are limited.
3) Temperature Sensitivity: Silicon and selenium-based X-ray detectors can be sensitive to temperature variations, which may affect their performance and stability over time. Fluctuations in temperature can lead to changes in detector sensitivity and image quality.
4) Radiation Damage: Prolonged exposure to X-rays can cause radiation damage to the semiconductor materials used in these detectors, leading to degradation of detector performance over time. This degradation may manifest as increased noise levels, reduced sensitivity, or pixel defects, affecting image quality and diagnostic accuracy.
5) Energy Dependency: The sensitivity of direct X-ray detectors based on silicon and selenium to X-ray photons may vary depending on the energy spectrum of the incident radiation. Calibration and correction procedures may be necessary to ensure consistent image quality across different X-ray energy ranges.

The 0D OMHH based direct X-ray detectors described herein offer several advantages over existing technologies, including, but not limited to:
1) High Sensitivity: OMHHs exhibit high sensitivity to X-ray photons, owing to the high X-ray absorption coefficients of metal halides. This high sensitivity enables the detection of low-intensity X-ray signals, resulting in enhanced image quality and diagnostic accuracy.
2) Fast Response Time: Organic semiconducting components in OMHHs have fast carrier transport properties, leading to rapid response times to X-ray photons. This fast response time allows for quick image acquisition, making them suitable for real-time imaging applications such as fluoroscopy and dynamic radiography.
3) Tunability: OMHHs can be chemically engineered to have specific optical and electrical properties, including bandgap, carrier mobility, and defect tolerance. This tunability allows for customization of the detector's characteristics to match the requirements of the imaging application, leading to optimized performance.
4) Flexibility and Conformability: OMHHs have the potential to offer flexibility and conformability, enabling the fabrication of detectors on flexible substrates. This flexibility allows for the development of lightweight and wearable X-ray detectors, expanding their potential applications in wearable healthcare devices and point-of-care diagnostics.
5) Low-Cost Fabrication: OMHHs can be processed using solution-based techniques, such as spin-coating or inkjet printing, on flexible and inexpensive substrates. This low-cost fabrication method reduces manufacturing expenses and makes large-scale production feasible, contributing to the commercial viability of the detectors.
6) Low-Temperature Processing: OMHHs can be processed at relatively low temperatures compared to conventional semiconductors, reducing energy consumption and production costs. This low-temperature processing also enables compatibility with flexible and lightweight substrates, expanding the range of potential applications.
7) Environmental Friendliness: OMHHs typically exhibit environmentally friendly properties, as they can be synthesized from abundant and non-toxic elements. This environmental friendliness is advantageous for sustainable manufacturing practices and disposal at the end of the device's lifecycle.

Overall, the OMHH based direct X-ray detectors described herein offer significant advantages in terms of sensitivity, response time, tunability, flexibility, low-cost fabrication, low-temperature processing, and environmental friendliness, making them promising candidates for advanced imaging technologies in medical and industrial fields.

### Example 2—Efficient and Stable Direct X-Ray Detectors Based on An Eco-Friendly Zero-Dimensional Organic Zinc Bromide Hybrid

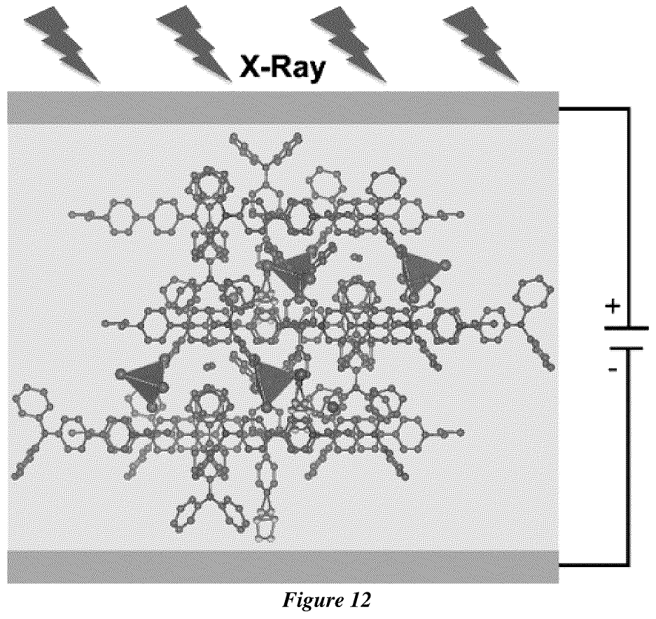

Abstract. Direct X-ray detectors that convert X-rays to electrical charges have broad applications in medicine and security screening. Common semiconductors like silicon and selenium for direct X-ray detectors have limitations in performance, versatility, and cost-effectiveness. Among new materials under investigation, metal halide perovskites demonstrate great potential for X-ray detectors; however, they are limited by low stability and toxicity. Here, it is reported, for the first time, a stable and eco-friendly zero-dimensional (0D) organic metal halide hybrid (OMHH), (TPA-P)₂ZnBr₄, for efficient X-ray detectors (FIG. 12). With molecular sensitization, wherein metal halides (ZnBr₄²⁻) act as X-ray absorbers and organic semiconducting components (TPA-P⁺, 4-(4-(diphenylamino) phenyl)-1-propylpyridin-1-ium) as charge transporters, 0D (TPA-P)₂ZnBr₄ detectors exhibit an impressive sensitivity of 2,292 μC Gyₐᵢᵣ⁻¹ cm⁻² at 20 V and a low detection limit of 37.5 nGyₐᵢᵣ s⁻¹. The exceptional stability of 0D (TPA-P)₂ZnBr₄ facilitates remarkably stable direct X-ray detection and shows the tremendous potential of rationally designed 0D OMHHs as new-generation radiation detection materials.

Introduction. Since the groundbreaking discovery of X-rays by Wilhelm C. Röntgen in 1895 [1], our world has continued to benefit from it in numerous aspects, from healthcare to security, scientific research, and industrial processes. Thanks to X-ray detectors developed over the years, X-ray imaging has been utilized for medical diagnostics like radiography and CT scans, homeland security screening, and many other applications [2-6]. To date, most commercially available direct X-ray detectors being used to convert X-rays into electrical signals are constructed with inorganic semiconductors, such as amorphous silicon and selenium [7, 8]. However, direct X-ray detectors based on pure inorganic semiconductors have many disadvantages, including cost, bulkiness, temperature sensitivity, radiation damage, and energy dependency [9]. Because of these limitations, semiconductor detectors are still behind other sensing technologies for wide adoption in the market. In recent years, researchers have explored new types of materials for direct X-ray detectors, for instance, metal halide perovskites and perovskite-related hybrid materials [3, 10-15]. Stoumpos et. al reported direct radiation detectors based on CsPbBr₃ in 2013 [10], which exhibited a high linear attenuation coefficient of about 1 μm⁻¹ at a photon energy range of 1-1000 KeV and a large carrier mobility lifetime product of 1.7×10⁻³ cm² V⁻¹, significantly higher than that of α-Se (˜10⁻⁷ cm² V⁻¹) [16]. Pan et. al also demonstrated X-ray detectors based on lead-free double-perovskite Cs₂AgBiBr₆ [17]. which exhibited high resistivities ranging from 10⁹-10¹¹ Ω cm, a large carrier mobility lifetime product of 6.3×10⁻³ cm²·V⁻¹, and a low limit of detection of around 59.7 nGyₐᵢᵣ s⁻¹. Despite many high figure-of-merits of perovskite-based detectors, metal halide perovskites with a 3D structure at the molecular level possess high charge carrier concentrations and exhibit high dark current due to unintentional self-doping effects [18-24]. Moreover, they often suffer from low stability, especially when exposed to moisture with water molecules that easily penetrate the crystal structure to weaken bonding interactions between metal halide polyhedral and small organic cations. This leads to free ionic migration and fast degradation [25-27]. To address both high dark current and stability issues, researchers have looked into lower dimensional materials with suppressed self-doping effects and reduced carrier concentrations, including 2-dimensional (2D), 1D, and 0D organic metal halide hybrids (OMHHs), where the steric effects introduced by bulky organic cations could minimize ion migration and increase the defect formation energy [20, 23, 28-30].

0D OMHHs, containing metal halide anions fully isolated and surrounded by organic cations, have recently emerged as a new class of functional materials with a wide range of applications, such as down-conversion emitters and X-ray scintillators [31-35]. The site isolation of metal halides by organic cations in 0D OMHHs grants them significantly greater stability when compared to 3D metal halide perovskites. This characteristic also endows them with substantial potential to achieve minimal current drift by effectively suppressing ionic migration [15]. Liu et. al reported the use of 0D (MA)₃Bi₂I₉ for X-ray detectors, which exhibited a low dark current of around 8 pA (electric field˜10 V mm⁻¹) [15]. You et al. reported a self-driven X-ray detector based on chiral 0D (R/S-PPA)₂BiI₅, showing a low dark current density (˜80 pA cm⁻² at zero bias) [36]. Although excellent photocurrent stability with low dark currents has been achieved in these 0D OMHHs-based X-ray detectors [15, 36], the low conductivity of 0D OMHHs due to the insulating nature of organic cations used in these materials leads to low sensitivity. To facilitate the use of 0D OMHHs in direct X-ray detectors, it is crucial to tackle the low electrical conductivity characteristic of existing OMHHs containing insulating organic cations. This could be achieved by developing 0D OMHHs that contain semiconducting organic cations.

Here, it is reported, for the first time, the use of a single crystalline 0D OMHH containing semiconducting organic cations, 0D (TPA-P)₂ZnBr₄, for the fabrication of high-performance direct X-ray detectors, where TPA-P⁺ represents 4-(4-(diphenylamino) phenyl)-1-propylpyridin-1-ium with a bandgap of 2.25 eV. By integrating wide bandgap ZnBr4²⁻ anions with bulky semiconducting TPA-P⁺ cations, a 0D (TPA-P)₂ZnBr₄with highly efficient molecular sensitization was achieved, where electrons can be ionized in the ZnBr₄₂₋ anions upon X-ray irradiation and transferred to semiconducting TPA-P⁺ organic cations for charge conduction. Subsequently, 0D (TPA-P)₂ZnBr₄-based direct X-ray detectors were fabricated to exhibit an impressive sensitivity of 2,292 μC Gyₐᵢᵣ⁻¹ cm⁻² at 20 V bias with a low detection limit of 37.5 nGyₐᵢᵣ s⁻¹. Electronic characterizations have revealed a low trap density of 2.86×10⁹ cm⁻³ and a high mobility lifetime product of 5.67×10⁻⁴ cm² V⁻¹ at 20 V for 0D (TPA-P)₂ZnBr₄ single crystals. The high resistivity of 5.05×10¹⁰ Ω cm of 0D (TPA-P)₂ZnBr₄ is crucial in realizing a very low and stable average dark current of around 13.4 pA under 24 hours of operation.

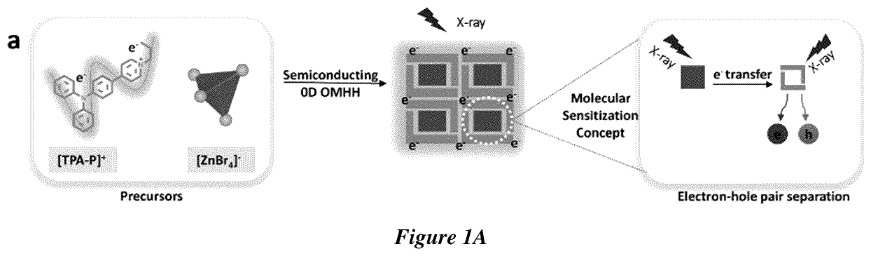

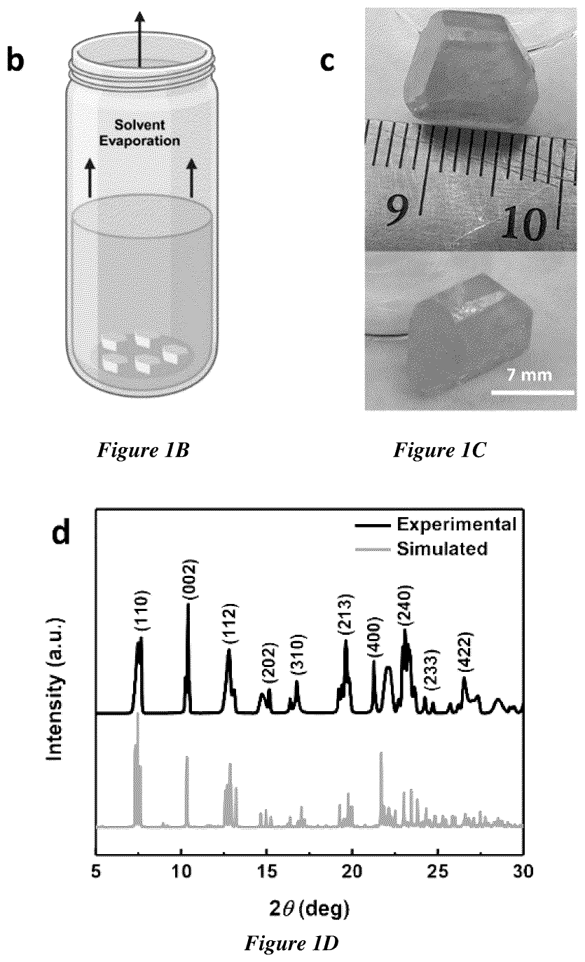

Material design, synthesis, and characterization. In 2023, application of 0D (TPA-P)₂ZnBr₄ for high-performance X-ray scintillation was reported, where metal halides ZnBr₄²⁻ act as sensitizers with high X-ray absorption and aggregation-induced emission (AIE) organic cations TPA-P⁺ act as efficient light emitters with a short decay lifetime of 3.52 ns [33]. Considering the semiconducting nature of TPA-P⁺ with a bandgap of 2.25 eV, it is believed that 0D (TPA-P)₂ZnBr₄ could also be used to fabricate direct X-ray detectors. FIG. 1A shows the concept of molecular sensitization of 0D (TPA-P)₂ZnBr₄ for direct X-ray detectors, where ZnBr₄²⁻ serves as the main X-ray absorber and TPA-P⁺ as the charge transporter. In other words, instead of reading visible light output from TPA-P⁺ in 0D (TPA-P)₂ZnBr₄-based X-ray scintillators, direct detection of electrical signals can be achieved in 0D (TPA-P)₂ZnBr₄-based direct X-ray detectors. Indeed, the molecular sensitization approach offers tremendous potential in enhancing the performance of direct X-ray detectors. First, it enables high X-ray detection sensitivity by using metal halides with strong X-ray absorption to sensitize lightweight semiconducting organic molecules. Unlike previous blended systems that combine high atomic weight metal nanoparticles with organic polymers, often hampered by issues of film uniformity and poor air stability [37, 38], molecular sensitization in 0D OMHHs relies on single crystals with highly ordered molecular structures. These crystalline structures provide improved uniformity, air stability, and more efficient energy transfer processes resulting in superior X-ray detection performance. Additionally, incorporating molecular sensitization into 0D OMHHs opens up opportunities for molecular design and engineering. By selecting organic molecules with excellent charge carrier mobilities, the electrical conductivity and sensitivity of X-ray detectors can be further enhanced.

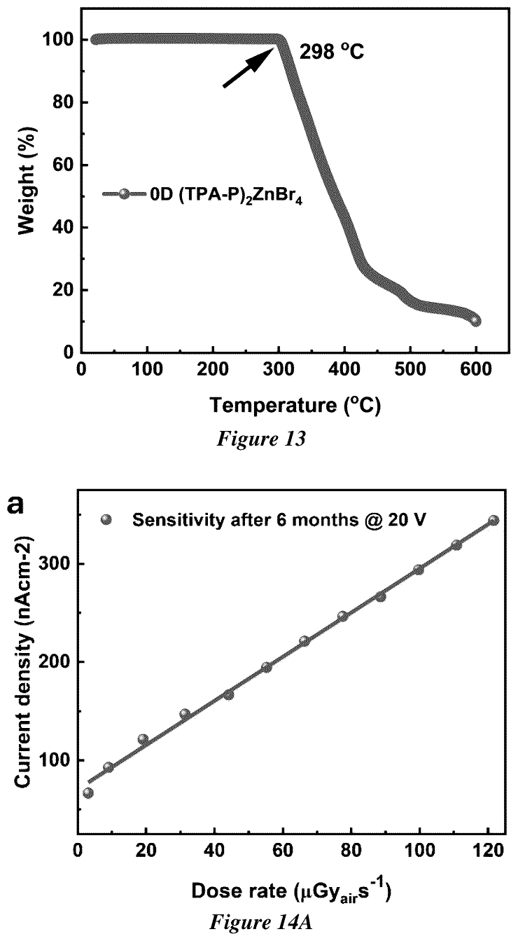

To obtain large single crystals of 0D (TPA-P)₂ZnBr₄ for the fabrication of direct X-ray detectors, the crystal growth method has been slightly changed from the previously used antisolvent diffusion growth to a slower room temperature evaporation method, as shown in FIG. 1B. More specifically, a precursor solution was prepared by dissolving TPA-PBr and ZnBr₂ in dimethylformamide (DMF) at a 2:1 mole ratio, respectively, which was filtered and placed in a large vial and gently left open at room temperature to achieve gradual evaporation of the solvent (FIG. 5). 0D (TPA-P)₂ZnBr₄ single crystals started to appear after 48 hours, and hexagonal-shaped single crystals with size dimension of up to 7 mm×3 mm×2 mm (FIG. 1C) could be prepared with excellent surface smoothness after around one week. The structure and composition of large size 0D (TPA-P)₂ZnBr₄ single crystals were confirmed to be the same as those of smaller single crystals previously prepared using the antisolvent diffusion growth method [33], with SCXRD data shown in Table 2. The powder X-ray diffraction (PXRD) patterns of powder samples obtained from large-size single crystals match perfectly with the simulated ones from single-crystal XRD, suggesting the high purity of the large single crystals. The thermal stability test, conducted using thermogravimetric analysis (TGA) (FIG. 13), indicates that the material remains stable and does not decompose until approximately 300° C.

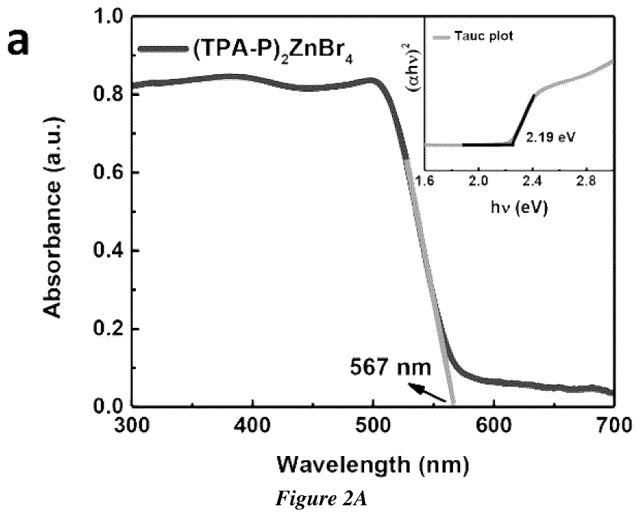

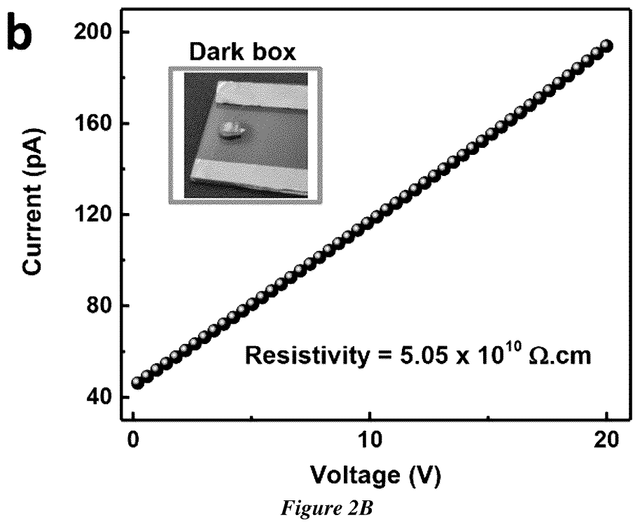

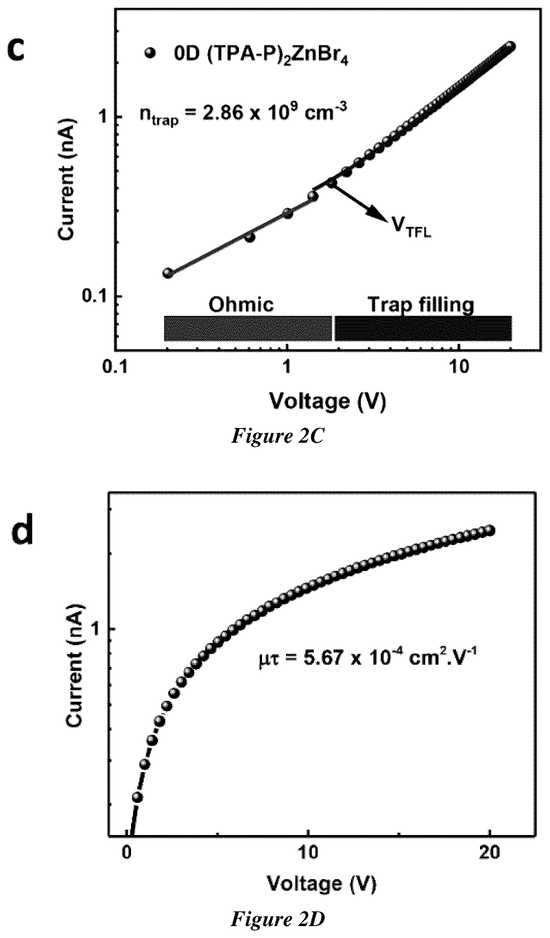

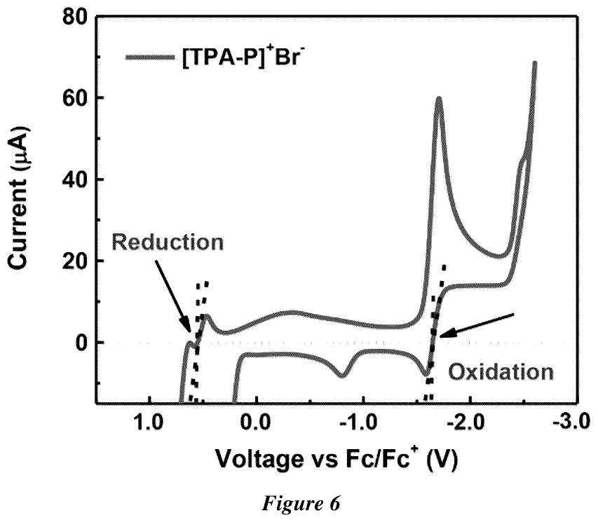

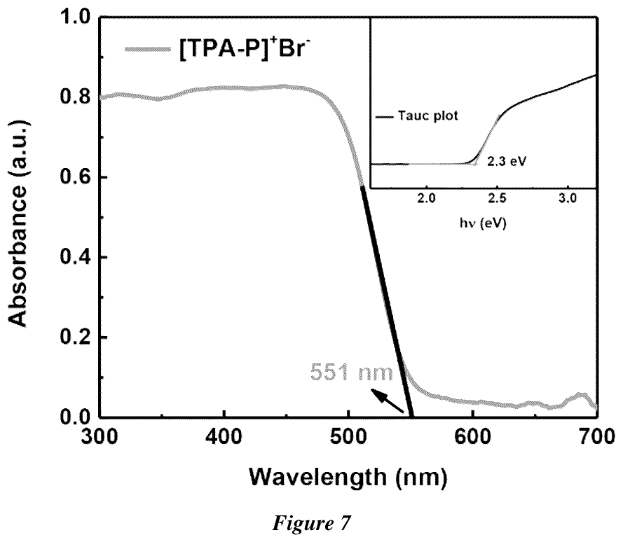

Photophysical and Electrical characterizations. The basic optical and electronic properties of large-size 0D (TPA-P)₂ZnBr₄ single crystals have been characterized. FIG. 2A shows the absorption spectrum of 0D (TPA-P)₂ZnBr₄ single crystals with an absorption edge cut-off at around 567 nm, from which the optical bandgap is estimated to be around 2.19 eV. TPA-PBr shows a similar bandgap of around 2.25 eV as determined by cyclic voltammetry (FIG. 6 and Table 1) and UV-Vis absorption spectroscopy (FIG. 7). The slightly decreased bandgap of 0D (TPA-P)₂ZnBr₄ as compared to TPA-PBr is likely due to the enhanced molecular packing of TPA-P⁺ cations in 0D (TPA-P)₂ZnBr₄ single crystals [33]. The resistivity of 0D (TPA-P)₂ZnBr₄ single crystals with a thickness of 1.2 mm in the dark was determined to be around 5.05×10¹⁰ Ω cm using a simple vertical two-terminal measurement as shown in FIG. 2B (see the experimental details in the methods section), which is three orders of magnitude higher than those of typical 3D MAPbX₃ (X=Cl, Br, I) perovskites single crystals [19], and similar to those of recently reported 0D MA₃Bi₂I₉ (3.75×10¹⁰ Ω cm) and 0D (R/S-PPA)₂BiI₅ (2.96×10¹⁰ Ω·cm) [15, 36].

TABLE 1
Values of cathodic and anodic potentials obtained from
the cyclic voltammogram of (TPA-PBr) and the associated
E_{LUMO} and E_{HOMO} respectively.
The bandgap of TPA-PBr, E₀ was calculated
as the difference between E_{LUMO} and E_{HOMO}.

| | Reduction | E_{LUMO} | Oxidation | E_{HOMO} | E₀ |
|---|---|---|---|---|---|
| | (V) | (eV) | (V) | (eV) | (eV) |
| TPA-PBr | 0.60 | 5.40 | −1.65 | 3.15 | 2.25 |

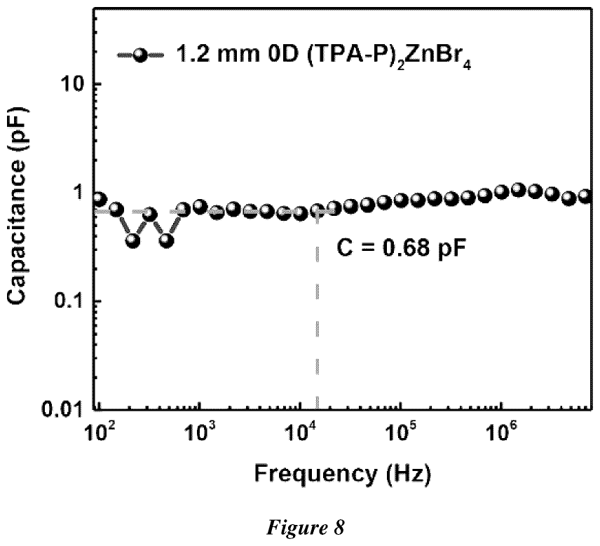

The trap density nₜᵣₐₚ of 0D (TPA-P)₂ZnBr₄ single crystal was further determined using the space charge-limited current (SCLC) method at a bias of 20 V. After fitting the dark I-V under the SCLC model as shown in FIG. 2C, two distinct regimes corresponding to I∝Vⁿ were identified, where n=1 and n>2 are ascribed to Ohmic and Trap-Filling Limited (TFL) regimes, respectively. The trap density nₜᵣₐₚ was then calculated by using the equation (1) as below:

$${n}_{trap} = \frac{2 {V}_{T F L} ε {ε}_{0}}{e {L}^{2}} \qquad ( 1 )$$

where V_{TFL} is the trap-fill voltage marking the transition from the Ohmic regime to the TFL regime of the I-V plot (1.82 V), ε₀ is the vacuum permittivity (8.854×10¹² Fm⁻¹), ε is the permittivity obtained from the Capacitance vs Frequency data plot in FIG. 8, e is the elementary charge of 1.602×10⁻¹⁹ C, and L is the thickness of the sample (1.2 mm) [39, 40]. The obtained nₜᵣₐₚ value of 2.86×10⁹ cm⁻³ is much lower than those of 2D and 3D halide perovskites, and comparable to those of 0D OMHHs [13, 40, 41]. To evaluate the potential of 0D (TPA-P)₂ZnBr₄ single crystals for direct X-ray detection, the carrier mobility lifetime product μτ was determined, which is an important parameter characterizing the carrier collection efficiency. Under continuous X-ray irradiation of 121.7 μGyₐᵢᵣ s⁻¹, the voltage-dependent photoconductivity of 0D (TPA-P)₂ZnBr₄ single crystal, μτ was estimated to be 5.67×10⁻⁴ cm²·V⁻¹ (FIG. 2D) according to the Modified Hecht equation (2) as below [42]:

$$I = \frac{{I}_{0} μτ V}{{L}^{2}} [ 1 - exp ( \frac{- {L}^{2}}{μτ V} ) ] \qquad ( 2 )$$

where L represents the thickness of the sample between two electrodes, and I₀ represents the saturated photocurrent reached under voltage bias V. It is found that the μτ of 0D (TPA-P)₂ZnBr₄ is three orders of magnitude higher than that of α-Se (10⁻⁷ cm² V⁻¹), and is comparable to 0D Cs₃Bi₂I₉ (7.97×10⁻⁴ cm² V⁻¹) [16, 40]. All the electrical characterization results of 0D (TPA-P)₂ZnBr₄ single crystals, i.e. a low trap density of 2.86×10⁹ cm⁻³ and a high carrier mobility lifetime product of 5.67×10⁴ cm² V⁻¹, confirm the effectiveness of the molecular design of 0D OMHHs herein containing bulky semiconducting organic cations for direct X-ray detectors.

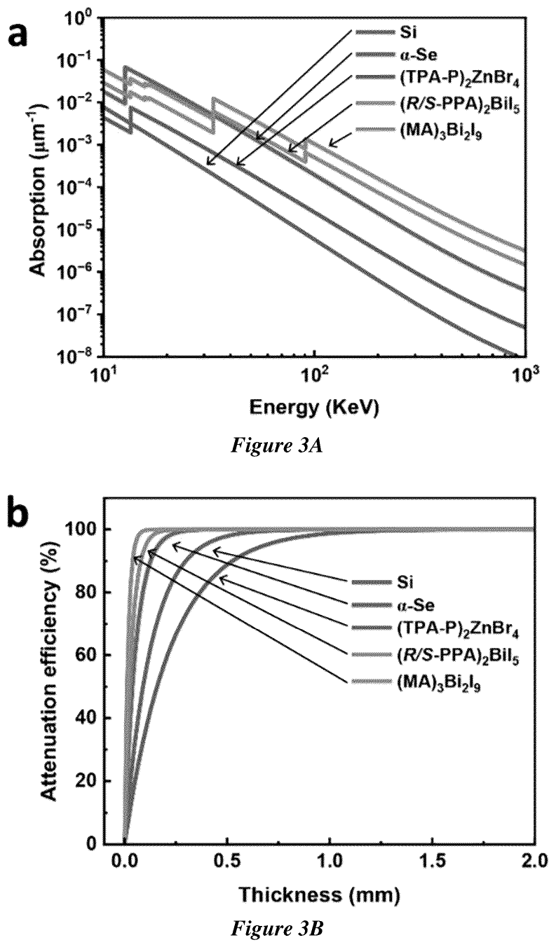

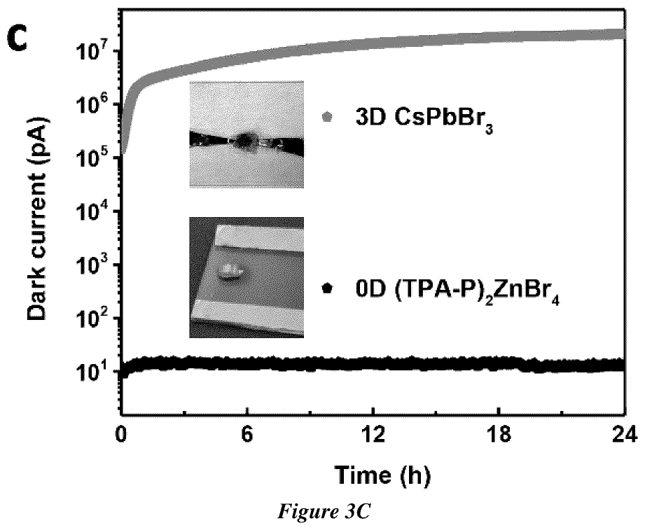

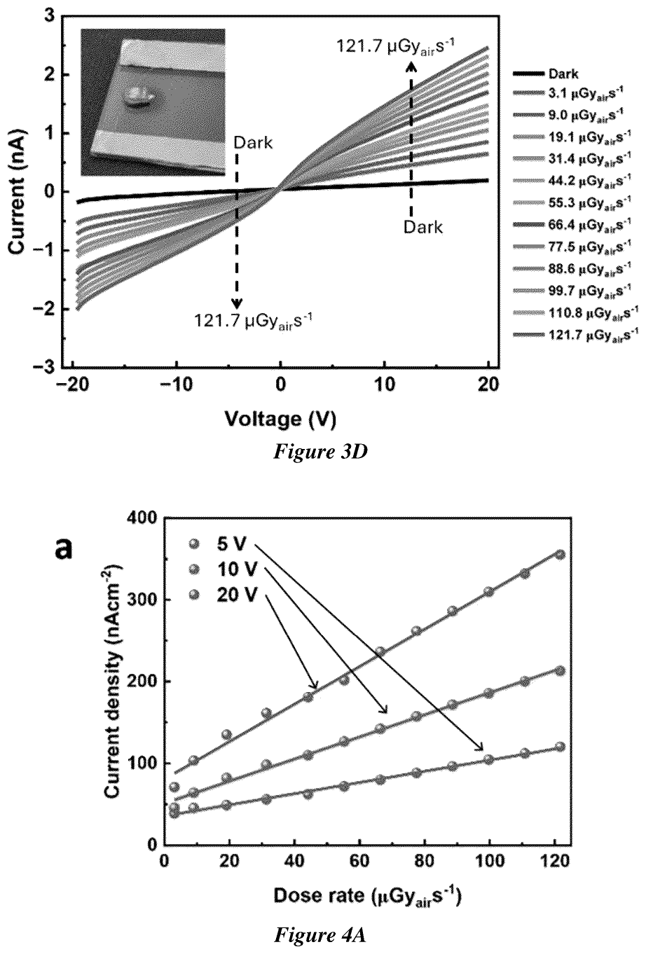

X-ray Detection Performance. The theoretical X-ray absorption coefficient of 0D (TPA-P)₂ZnBr₄ within a range of practical photon energies from 10 to 1000 keV was calculated using a photon cross-section database [43], as shown in FIG. 3A. It is found that 0D (TPA-P)₂ZnBr₄ with a density of 1.54 g cm⁻³ has a slightly lower absorption coefficient than those of α-Se (4.25 g cm⁻³) and 0D bismuth halide hybrids, such as MA₃Bi₂I₉ (4.11 g cm⁻³) and (R/S-PPA)₂BiI₅ (2.51 g cm⁻³) [15, 16, 36, 44]. FIG. 3B shows the attenuation efficiency versus thickness plots for 0D (TPA-P)₂ZnBr₄ and several known X-ray detection materials. A thickness of around 1.1 mm is needed for 0D (TPA-P)₂ZnBr₄ single crystals to achieve near-unity attenuation at 10.3 KeV energy, which is not surprising considering the relatively low Z compositions of 0D (TPA-P)₂ZnBr₄ as compared to those of other materials. On the other hand, the material described herein can be upscaled to the volume needed for the desired attenuation at a low cost.

Direct X-ray detectors based on 0D (TPA-P)₂ZnBr₄ were fabricated using a vertical photoconductor architecture with single crystals of around 1.1 mm thick sandwiched between a pair of silver electrodes, as shown in the inset of FIG. 3C. The performance of devices based on 0D (TPA-P)₂ZnBr₄ single crystals were compared to a control device based on a 3D CsPbBr₃ single crystal. As shown in FIG. 3C, devices based on 0D (TPA-P)₂ZnBr₄ possess an average dark current of around 13 pA under 5 V bias, which is significantly lower than that of CsPbBr₃-based devices averaged at 14 μA when driven at the same bias. Moreover, the dark current of devices based on 0D (TPA-P)₂ZnBr₄ remains largely unchanged during continuous operation for over 24 hours [45]. In contrast, the devices based on 3D CsPbBr₃ single crystals undergo significant drifting, where the dark current increases by almost 100 times after 24 hours of voltage stress in the dark. This dark baseline drifting is likely attributed to the voltage-induced ion migrations in 3D perovskites, where mobile ions can create conducting channels through the surface with increased dark currents [25, 46]. In OMHHs with reduced dimensionalities, the steric hindrance of large organic cations has been shown to suppress defect formation with an ultralow self-doping, resulting in a significantly suppressed ion migration and dark current, which is highly desired for radiation detectors [19, 20, 23].

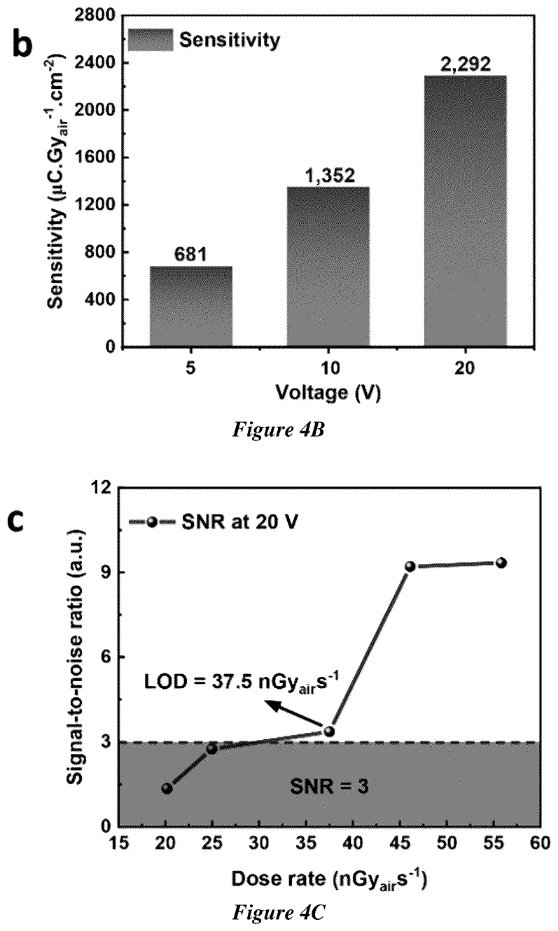

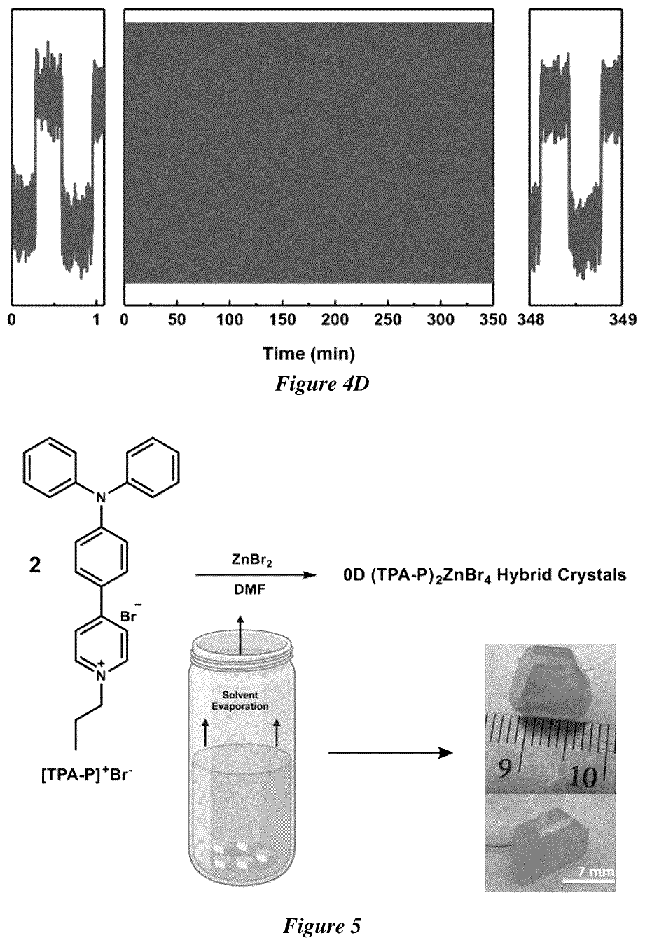

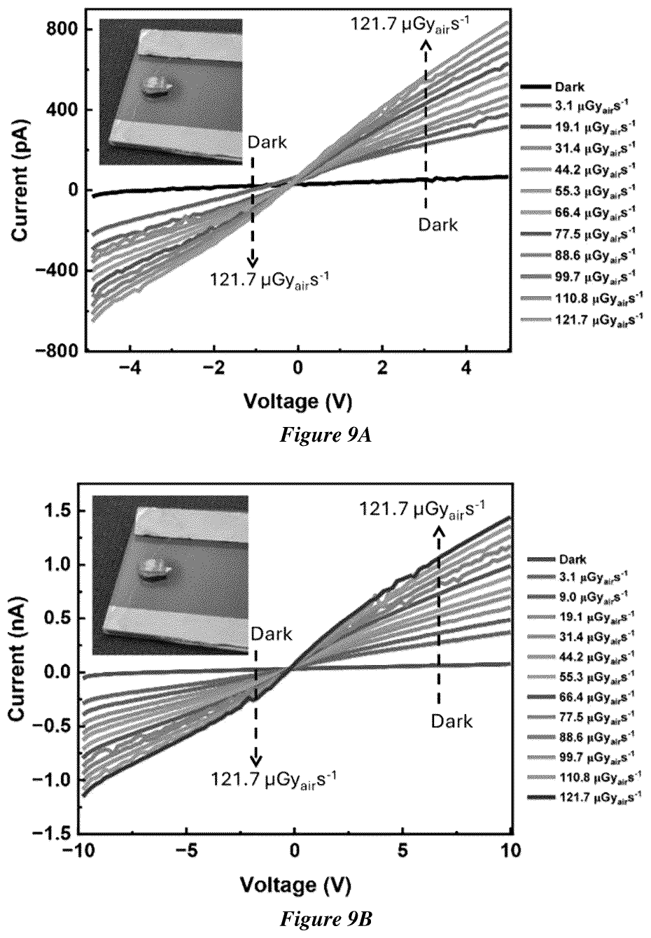

The X-ray detection performance of devices based on 0D (TPA-P)₂ZnBr₄ with an electrode area of 0.8×0.8 mm² were further characterized at various radiation dose rates and biases. FIG. 3D shows the current-voltage characteristics of the device, which were measured under different X-ray dose rates with bias sweeping from −20 to 20 V (FIG. 9A and FIG. 9B for smaller voltage ranges). It is clearly shown that the measured device current rises upon the increase of X-ray dose rate throughout the whole operation voltages. For instance, at 20 V, the current changes from 0.19 nA in the dark to 0.65 nA at the X-ray dose rate of 3.1 μGyₐᵢᵣ s⁻¹, more than 200% enhancement, which reached 2.47 nA at the X-ray dose rate of 121.7 μGyₐᵢᵣ s⁻¹. The X-ray detection sensitivity of the device was evaluated at different operation voltages (5, 10, and 20 V). As shown in FIG. 4A, the sensitivity was extracted from the plots of current density vs. X-ray dose rate at different voltages by using equation (3) as below:

$$S = \frac{( {J}_{X - ray} - {J}_{d a r k} )}{D} \qquad ( 3 )$$

where, S represents the sensitivity, J_{X-ray} and J_{dark} represent the photocurrent and dark current densities, respectively, and D is the dose rate of X-ray. A sensitivity of 681 μC Gyₐᵢᵣ⁻¹ cm⁻² is achieved for the device at 5 V, which increases to 1,352 μC Gyₐᵢᵣ⁻¹ cm⁻² at 10 V, and 2,292 μC Gyₐᵢᵣ⁻¹ cm⁻² at 20 V (FIG. 4B). These values of X-ray detection sensitivity are indeed higher than that of commercially available detectors based on amorphous selenium (˜22 μC Gyₐᵢᵣ⁻¹ cm⁻²) [16]. Next, the limit of detection (LOD), one of the most important characteristics of radiation detectors for medical diagnostics and imaging applications [17, 28], was determined for the device by taking multiple measurements within the region of low X-ray dose rates from 16 nGyₐᵢᵣ s⁻¹ to 60 nGyₐᵢᵣ s⁻¹ at 20 V (an electric field of 16.7 V·mm⁻¹). According to the International Union of Pure and Applied Chemistry (IUPAC), the LOD is defined as the dose rate at a signal-to-noise ratio (SNR) of around 3, and for the device herein, the LOD is estimated to be 37.5 nGyₐᵢᵣ s⁻¹, with an SNR value of 3.36, as shown in FIG. 4C. This LOD value is about 150 times lower than the X-ray dose rate of 5.5 μGyₐᵢᵣ s⁻¹ required for common medical diagnostics [11]. Note that the detection limit measurement was conducted with a current meter without additional signal filters in the circuit. With a more delicate electrical circuit design to filter out the high-frequency noises, one would expect a better SNR, and thus, even lower LOD.

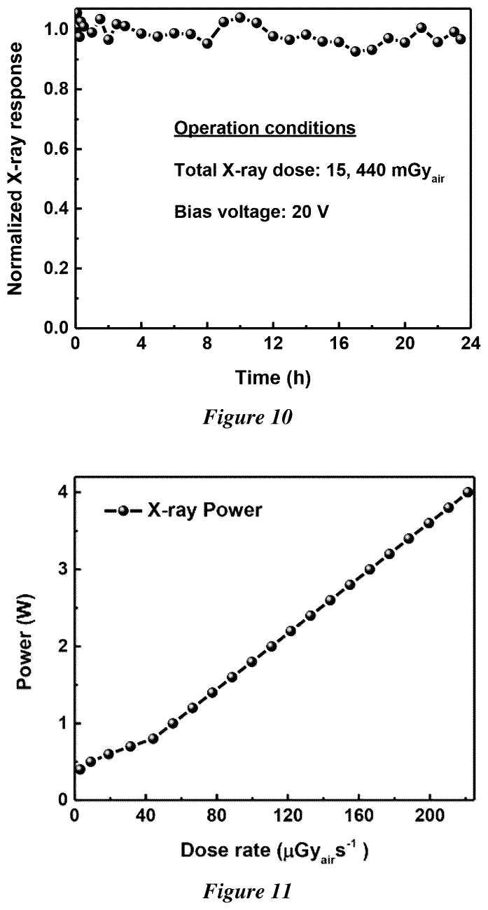

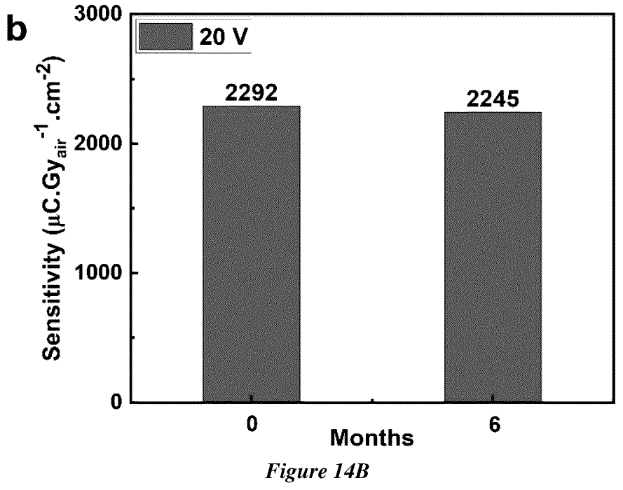

Finally, the operational stability of the 0D OMHH devices was investigated. First, the detector was stressed under continuous X-ray irradiation with a dose rate of 178.7 μGyₐᵢᵣ s⁻¹ and at 20 V driving voltage for 24 hours in ambient air with a relative humidity of around 35%. The time evolution of the X-ray-induced current is shown in FIG. 10. It can be seen that the X-ray response of the device remains largely unchanged even after being exposed to an accumulative total dosage of 15,440 mGyₐᵢᵣ of X-ray. Next, the detector was cycled by turning the X-ray beam on and off periodically with a 20 s interval and monitored the X-ray-induced current from the detector. The X-ray dosage was kept at 178.7 μGyₐᵢᵣ s⁻¹ dose rate. As shown in FIG. 4D, the device exhibits little-to-no drift in X-ray response after more than 580 continuous cycles. The long-term stability of the detector was further evaluated. FIG. 14A shows that the device maintained stable and linear X-ray detection sensitivity at 20 V even 6 months after initial testing. At the same time, FIG. 14B confirms there was almost no change in sensitivity upon retesting after 6 months. These findings underscore the superior stability of the devices described herein, and highlights the potential of 0D OMHHs for practical radiological applications, where long-term stability is required.

Conclusion. In summary, the use of a semiconducting 0D organic metal halide hybrid (TPA-P)₂ZnBr₄ for the fabrication of high-performance direct X-ray detectors is reported, which exhibit a detection sensitivity of 2,292 μC Gyₐᵢᵣ⁻¹ cm⁻² at 20V with a low detection limit of 37.5 nGyₐᵢᵣ s⁻¹. The direct X-ray detection using 0D (TPA-P)₂ZnBr₄ involves efficient molecular sensitization, where large bandgap metal halide species ZnBr₄²⁻ act as X-ray absorber and organic semiconducting cations TPA-P⁺ as charge transporter. The direct X-ray detectors have also shown superior long-term operational stability while being tested under a high dosage of accumulated X-ray irradiation at 20 V. The combination of low-cost facile preparation of the material, high detection sensitivity, low detection limit, and superior stability make direct X-ray detectors based on 0D organic metal halide hybrids highly promising for many practical applications, ranging from medical diagnostics to imaging, therapy, security, and scientific elucidations. This work once again shows the exceptional structural tunability and rich functionalities of 0D organic metal halide hybrids with potential applications across a wide range of areas.

### Supplementary Information

Methods and Materials. Zinc bromide (99.9%), 4-Bromotriphenylamine (97%), pyridine-4-boronic acid (90%), potassium carbonate (≥99.0%), tetrahydrofuran (THF, ≥99.9%), tetrakis (triphenylphosphine)-palladium (0) (99%), methanol (MeOH, ≥99.9%), propyl bromide (99%), dichloromethane (DCM, ≥99.8%) were all purchased from Sigma Aldrich. Diethyl ether (Et₂O, ≥99.9%) and N,N-Dimethylformamide (DMF ≥99.8%) were purchased from VWR. All materials upon purchase were used directly without a need for further purification.

Synthesis of TPA-PBr salt. In brief, the first step involved a stoichiometric molar ratio of 4-bromotriphenylamine and pyridine-4-boronic acid refluxed in a 1:1 volume mixture of THF and methanol at 90 C for 36 hours. Tetrakis (triphenylphosphine)-palladium(0) was used to catalyze the Suzuki-coupling reaction in the presence of potassium carbonate and nitrogen gas. The dark mixture obtained after refluxing was purified by column chromatography to get a clear light-yellow solid with a 78% yield. In the second step, the clear light-yellow solid was reacted with propyl bromide and refluxed at 90° C. for only 1 hour. Upon completion of the reaction, bright yellow TPA-PBr salt was obtained and recrystallized in diethyl ether to obtain a yield of about 90%. The detailed synthetic and structural characterization can be found elsewhere [A1].

Growth of 0D (TPA-P)₂ZnBr₄ single crystals. To prepare a precursor solution of 0D (TPA-P)₂ZnBr₄, a stoichiometric molar ratio of 2:1 TPA-PBr and ZnBr₂, respectively, was dissolved in DMF to an appropriate concentration. This was followed by filtering the precursor into a clean vial for crystal growth. The filtered precursor solution was then gently kept at room temperature to allow for a gradual evaporation of the solvent, and this led to the appearance of 0D (TPA-P)₂ZnBr₄ within two days. Crystals with larger sizes for device fabrication were obtained after further evaporation of the solvent from the precursor solution after about one week.

Material characterization. Ultra-violet visible solid-state absorption spectra of both TPA-PBr and (TPA-P)₂ZnBr₄ were measured at room temperature using an Edinburgh FS5 coupled with an Edinburgh SC-30 integrating sphere. A 150 W Xe lamp was used as the light source and absorption was measured from 300 nm to 700 nm. Single-crystal X-ray data for 0D (TPA-P)₂ZnBr₄ was collected using a Rigaku XtaLAB Synergy-S diffractometer equipped with a HyPix-6000HE Hybrid Photon Counting (HPC) detector and dual Mo and Cu microfocus sealed X-ray source at 298 K. Powder XRD patterns of (TPA-P)₂ZnBr₄ were obtained with crushed powders from large-grown crystals by using a Rigaku SmartLab diffractometer having a Cu Kα radiation source (where λ=1.542 Å). At room temperature, the diffractometer's X-ray tube was operated at 40 KV and 44 mA, while recording the XRD patterns from a 20 of 5° to 50°, using a step size of 0.01°. The thermal stability study was carried out using the TA instruments Q600 system. The sample was heated from room temperature to 700° C. at a 5° C. min⁻¹ rate under an argon flux of 100 mL min⁻¹.

Device fabrication. (TPA-P)₂ZnBr₄ detectors were fabricated based on a simple vertical photoconductor structure, where Ag paste was carefully coated onto two flat surfaces of the crystal to form a vertical Ag/(TPA-P)₂ZnBr₄/Ag photoconductor architecture. Two tiny Pt wires were then attached to the Ag-coated crystal surfaces to connect the device to external circuitry. The active area of the electrode was estimated as 0.8 by 0.8 mm². All devices were constructed on prewashed glass substrates.

X-ray detector measurement. Current-voltage characteristics were measured for fabricated devices using a PV Measurements semiconductor characterization workstation. A Keithley 2400 SourceMeter was employed to simultaneously apply different bias voltages and measure the corresponding current responses all through the experiments. For the X-ray detection measurements, a commercially available MOXTEX X-ray tube was secured, with a tungsten anode target, and a maximum power of 4 W. FIG. 11 shows the calibrated doses obtained by varying the X-ray tube voltage and current.

The X-ray stability test was done by exposing the device under an X-ray beam generated by Cu-K alpha anode (8.1 keV peak energy). A bias was constantly applied over one electrode, and the X-ray-induced current was read out from the counter electrode. The device was kept under ambient air, and the humidity levels were recorded daily during the measurement.

TABLE 2
Crystal data and structure refinement for
0D (TPA-P)₂ZnBr₄ at room temperature.

| | |
|---|---|
| CCDC number | 2181767 |
| Empirical formula | C₅₂H₅₀Br₄N₄Zn |
| Formula weight | 1115.98 |
| Temperature [K] | 297(5) |
| Crystal system | monoclinic |
| Space group (number) | P2₁ (4) |
| a [Å] | 16.77500(10) |
| b [Å] | 17.22090(10) |
| c [Å] | 17.22800(10) |
| α [°] | 90 |
| β [°] | 91.9160(10) |
| γ [°] | 90 |
| Volume [Å³] | 4974.05(5) |
| Z | 4 |
| ρ_{calc} [gcm⁻³] | 1.502 |
| μ [mm⁻¹] | 4.776 |
| F(000 | 2252 |
| Radiation | Cu Kα (λ = 1.54184 Å) |
| 2θ range [°] | 7.24 to 156.35 (0.79 Å) |
| Index ranges | −21 ≤ h ≤ 21 |
| | −21 ≤ k ≤ 21 |
| | −19 ≤ l ≤ 21 |
| Reflections collected | 101812 |
| Independent reflections | 20844 |
| Completeness to θ = 67.684° | 100.0% |
| Data/Restraints/Parameters | 20844/1/1129 |
| Goodness-of-fit on F² | 1.059 |
| Final R indexes | R₁ = 0.0472 |
| [I ≥ 2σ(I)] | wR₂ = 0.1452 |
| Final R indexes | R₁ = 0.0593 |
| [all data] | wR₂ = 0.1564 |
| Largest peak/hole [eÅ⁻³] | 0.99/−0.49 |
| Flack X parameter | −0.014(7) |

Cyclic voltammetry. Cyclic voltammetry measurement was conducted in anhydrous dichloromethane under nitrogen to obtain both the cathodic (reduction) and anodic (oxidation) potentials. 0.1 M tetra (n-butyl)-ammonium hexafluorophosphate was used as the supporting electrolyte, which contained a 2 mM ferrocene as an internal standard. To complete the electrochemical set-up, glassy carbon, Ag wire, and Pt wire functioned as the working, auxiliary, and quasi-reference electrodes [A2]. The cathodic and anodic peak potentials relative to ferrocenium/ferrocene (Fc⁺/Fc) were substituted into the following equations below to obtain E_{LUMO} and E_{HOMO} [A3, A4].

$${E}_{LUMO} = ( {E}_{red onset} + 4 \text{.8} ) eV \qquad ( S 1 )$$

$${E}_{HOMO} = ( {E}_{ox onset} + 4 \text{.8} ) eV \qquad ( S 2 )$$

Electrochemical impedance. Using a 1.2 mm thick (TPA-P)₂ZnBr₄ crystal, the electrochemical impedance measurement was carried out on a Biologic-SP300 electrochemical analyzer within a frequency range from 1 Hz to 7 MHz. The device capacitance was then carefully extracted at the high-frequency regime, which corresponds to the range of thickness of the devices herein and also coincides with the flattening of the line [A5, A6]. The relative dielectric constant value of 20.45 was obtained using the equation below:

$$ε = \frac{c d}{{ε}_{0} A} \qquad ( S3 )$$

where c, d, ε₀, and A represent the capacitance value, the thickness of the capacitor, the vacuum permittivity, and the capacitor's area.

Signal-to-noise Ratio (SNR) Calculation for Limit of Detection (LOD) Estimation. According to The International Union of Pure and Applied Chemists (IUPAC), the LOD is estimated as the dose rate where the SNR is approximately equal to 3, where:

$$S N R = \frac{{I}_{s i g n a l}}{{I}_{n o i s e}} \qquad ( S4 )$$

$${I}_{s i g n a l} = A v {g}_{X r a y} - A v {g}_{d a r k} \qquad ( S5 )$$

where Avg_{Xray} is the average of the X-ray currents at a particular dose rate and Avg_{dark} is the average of the dark currents. Iₙₒᵢₛₑ is the standard deviation of the X-ray current and is given by the following equation:

$${I}_{n o i s e} = \sqrt{\frac{1}{N} {\sum }_{i}^{N} {( {I}_{X r a y} - A v {g}_{X r a y} )}^{2}} \qquad ( S6 )$$

where I_{Xray} is the X-ray current measured at a particular dose rate.

### REFERENCES

1 Kotzur, I. Radiology 193, 329-332 (1994).
2 Kasap, S. O. & Rowlands, J. Proceedings of the IEEE 90, 591-604 (2002).
3 Yakunin, S. et al. Nature photonics 9, 444-449 (2015).
4 Tegze, M. & Faigel, G. Nature 380, 49-51 (1996).
5 Woodford C et al. Non-destructive testing and radiation in industry. (2001).
6 He Y et al. Nat. Photonics 2024, 18, 1052-1058.
7 Zhao, W. & Rowlands, J. A. Medical physics 22, 1595-1604 (1995).
8 Heiss, W. & Brabec, C. Nature Photonics 10, 288-289 (2016).
9 Kasap, S. et al. Sensors 11, 5112-5157 (2011).
10 Stoumpos, C. C. et al. Crystal growth & design 13, 2722-2727 (2013).
11 Wei, H. et al. Nature Photonics 10, 333-339 (2016).
12 Wei, W. et al. Nature Photonics 11, 315-321 (2017).
13 Di, J. et al. Low trap density para-F substituted 2D PEA2PbX4 (X=Cl, Br, I) single crystals with tunable optoelectrical properties and high sensitive x-ray detector performance. Research (2022).
14 Wang, B. et al. ACS Energy Letters 8, 4406-4413 (2023).
15 Liu, Y. et al. Matter 3, 180-196 (2020).
16 Kasap, S. Journal of physics D: Applied physics 33, 2853 (2000).
17 Pan, W. et al. Nature photonics 11, 726-732 (2017).
18 Wei, H. et al. Nature materials 16, 826-833 (2017).
19 Wei, H. & Huang, J. Nature communications 10, 1066 (2019).
20 Lin, Y. et al. ACS Energy Letters 2, 1571-1572 (2017).
21 Xu, X. et al. EcoMat 2, e12064 (2020).
22 Koenraad, P. M. & Flatté, M. E. Nature materials 10, 91-100 (2011).
23 Peng, W. et al. Nano letters 17, 4759-4767 (2017).
24 Wang, Q. et al. Applied Physics Letters 105 (2014).
25 Boyd, C. C. et al. Chemical reviews 119, 3418-3451 (2018).
26 Christians, J. A. et al. JACS 137, 1530-1538 (2015).
27 Habisreutinger, S. N. et al. Nano letters 14, 5561-5568 (2014).
28 Zhuang, R. et al. Nature Photonics 13, 602-608 (2019).
29 Xiao, X. et al. ACS Energy Letters 3, 684-688 (2018).
30 Li, W. et al. Adv. Mater. 2024, 36, No. 2309588
31 Zhou, C. et al. Chemical science 9, 586-593 (2018).
32 He, Q. et al. ACS Materials Letters 2, 633-638 (2020).
33 Shonde, T. B. et al. Advanced Materials 35, 2301612 (2023).
34 Shonde, T. B. et al. ACS Materials Letters 4, 271-276 (2022).
35 Xu, L.-J. et al. Nature communications 11, 4329 (2020).
36 You, S. et al. Advanced Functional Materials 33, 2303523 (2023).
37 Thirimanne, H. et al. Nat. Commun. 2018, 9 (1), 2926.
38 Li, H. et al. Journal of Materials Chemistry C 2018, 6 (44), 11961-11967.
39 Tsai, H. et al. Science advances 6, eaay0815 (2020).
40 Zhang, Y. et al. Nature communications 11, 2304 (2020).
41 Peng, J. et al. Nature communications 12, 1531 (2021).
42 Feng, Y. et al. Journal of Materials Chemistry C 8, 11360-11368 (2020).
43 Berger, M. XCOM: photon cross sections database. http://www. nist. gov/pml/data/xcom/index. cfm (2010).
44 Reyes-Retana, J et al. Computational materials science 47, 934-939 (2010).
45 Yang, B. et al. Nature communications 10, 1989 (2019).
46 Leijtens, T. et al. Advanced Energy Materials 5, 1500962 (2015).
A1 Shonde, T. B. et al. Adv. Mater. 2023, 35 (23), 2301612
A2 Chaaban, M. et al. Inorganic Chemistry 59, 13109-13116 (2020).
A3 Shafiee, A. et al. Sains Malaysiana 40, 173-176 (2011).
A4 Pron, A. et al. Chemical Society Reviews 39, 2577-2632 (2010).
A5 Tsai, H. et al. Science advances 6, eaay0815 (2020).
A6 Zhang, Y. et al. Nature communications 11, 2304 (2020).

### Example 3

In addition to the compounds described and tested in Example 1, 0D (TPA-P)₂Zn₁₄, 0D (TPA-P)₂Cu₂I₄, 0D (TPA-P)₄Bi₄I₁₆ were synthesized and tested.

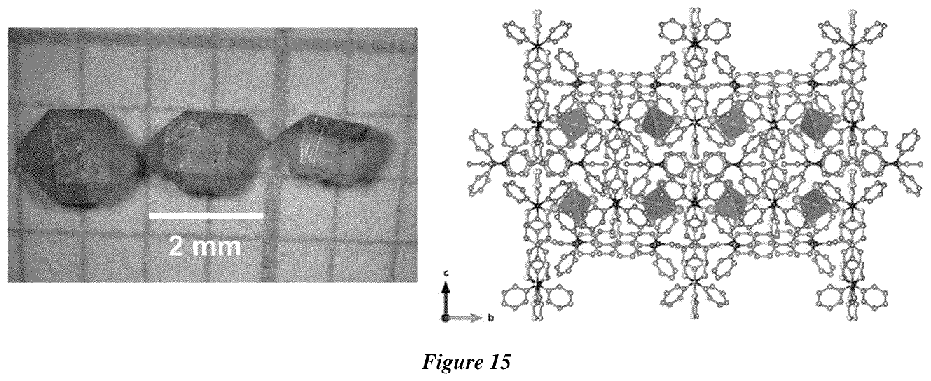

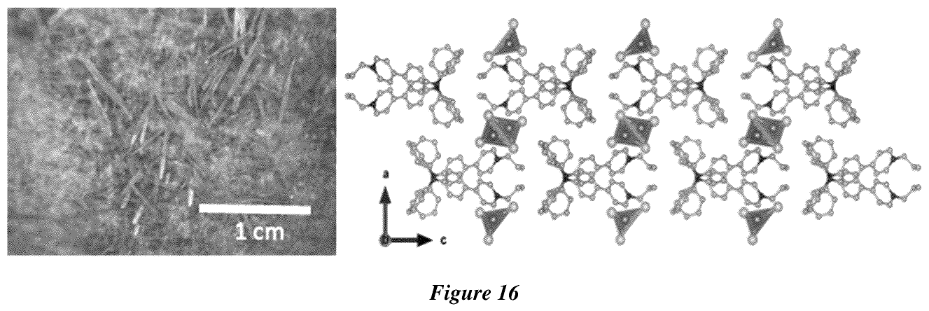

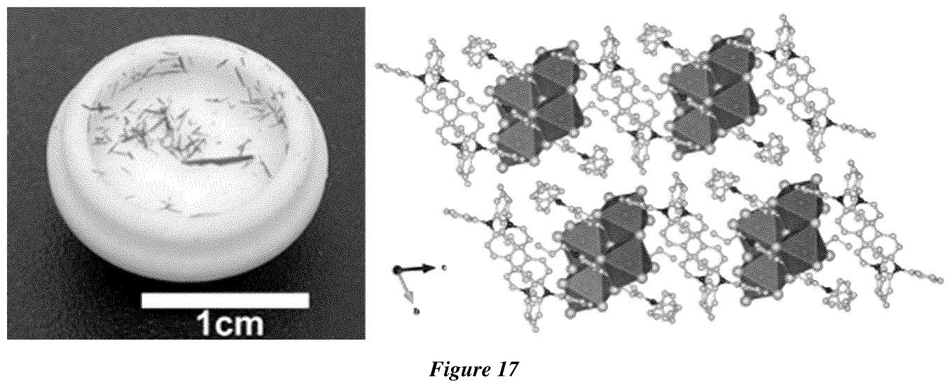

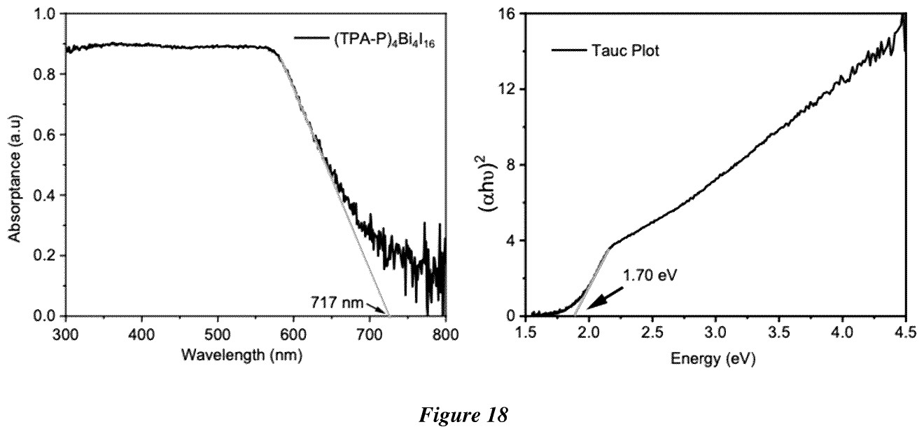

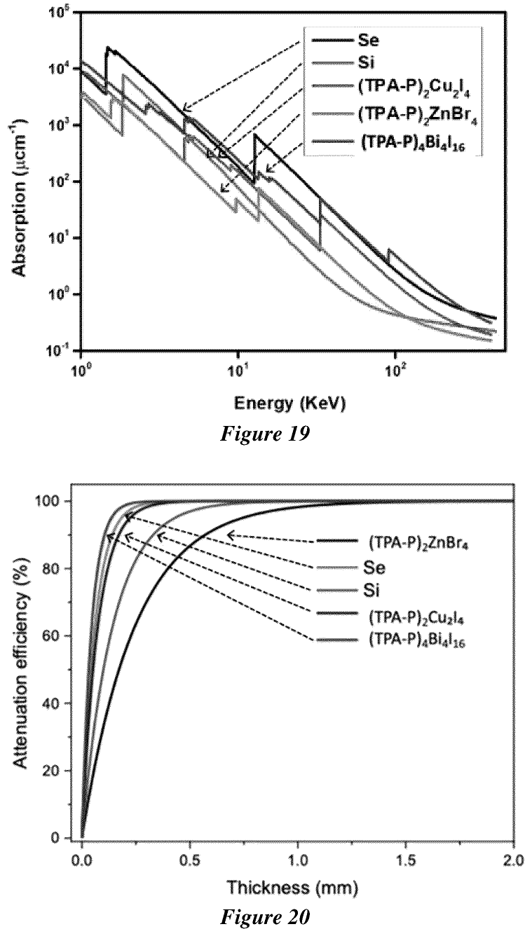

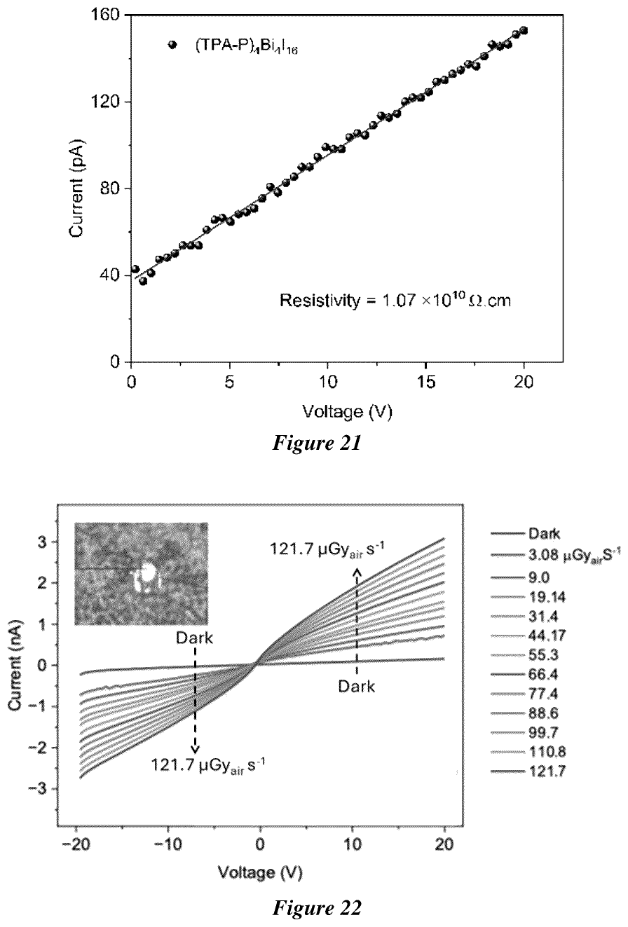

Results are shown in FIG. 15-FIG. 22.

### Exemplary Aspects

In view of the described compositions, devices, systems, and methods, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.
Example 1: A direct X-ray detector comprising an organic metal halide hybrid (OMHH) material and a first and a second electrode.
Example 2: The direct X-ray detector of any example herein, particularly example 1, wherein the OMHH has a composition of RₖMₗXₘ, wherein R is a semiconducting organic cation, M is a metal chosen from Zn, Cu, Mn, Pb, Sn, Sb, and Bi, and X is a halide chosen from Cl, Br, I, and combinations thereof, and wherein k, l, and m are integers.
Example 3: The direct X-ray detector of any example herein, particularly example 2, wherein the OMHH has a composition of (R)₂MX₄, (R)₂M₂X₄, or (R)₄M₄X₁₆.
Example 4: The direct X-ray detector of any example herein, particularly examples 2-3, wherein the OMHH has a composition of (R)₂MX₄.
Example 5: The direct X-ray detector of any example herein, particularly examples 2-4, wherein the semiconducting organic cation of the OMHH is a charge transporter.
Example 6: The direct X-ray detector of any example herein, particularly examples 1-5, wherein an organic moiety of the OMHH comprises a 4-(4-(diphenylamino) phenyl)-1-propylpyridin-1-ium (TPA-P⁺).
Example 7: The direct X-ray detector of any example herein, particularly examples 1-6, wherein a metal halide of the OMHH is an X-ray absorber.
Example 8: The direct X-ray detector of any example herein, particularly examples 1-7, wherein a metal halide of the OMHH comprises Zn, Cu, Bi, and a halide, wherein the halide is one of Br, Cl, I, or combinations thereof.
Example 9: The direct X-ray detector of any example herein, particularly examples 1-8, wherein a metal halide of the OMHH comprises Zn and a halide, wherein the halide is one of Br, Cl, I, or combinations thereof.
Example 10: The direct X-ray detector of any example herein, particularly examples 1-9, wherein the OMHH material comprises (TPA-P)₂ZnX₄, (TPA-P)₂Cu₂X₄, or (TPA-P)₄Bi₄X₁₆.
Example 11: The direct X-ray detector of any example herein, particularly examples 1-10, wherein the OMHH material comprises (TPA-P)₂ZnBr₄, (TPA-P)₂Zn₁₄, (TPA-P)₂Cu₂I₄, or (TPA-P)₄Bi₄I₁₆.
Example 12: The direct X-ray detector of any example herein, particularly examples 1-11, wherein the OMHH material comprises (TPA-P)₂ZnX₄.
Example 13: The direct X-ray detector of any example herein, particularly example 12, wherein the OMHH material comprises (TPA-P)₂ZnBr₄.
Example 14: The direct X-ray detector of any example herein, particularly examples 1-13, wherein the OMHH material is zero-dimensional.
Example 15: The direct X-ray detector of any example herein, particularly examples 1-14, wherein the OMHH material is a single crystal.
Example 16: The direct X-ray detector of any example herein, particularly examples 1-15, wherein the OMHH material is produced by solution-based processing.
Example 17: The direct X-ray detector of any example herein, particularly examples 1-16, wherein the OMHH material is produced by low-temperature processing.
Example 18: The direct X-ray detector of any example herein, particularly examples 1-17, the first and the second electrode comprise Au, Ag, indium tin oxide (ITO), carbon nanotubes (CNT), Cu, Ni, Al, etc., or combinations thereof.
Example 19: The direct X-ray detector of any example herein, particularly examples 1-18, the first and the second electrode comprise Au, Ag, indium tin oxide (ITO), or combinations thereof.
Example 20: The direct X-ray detector of any example herein, particularly examples 1-19, wherein the direct X-ray detector has a working arca of 0.8 by 0.8 mm².
Example 21: The direct X-ray detector of any example herein, particularly example 20, wherein the direct X-ray detector has a bias-dependent photoconductivity of 5.67×10⁻⁴ cm²·V⁻¹.
Example 22: The direct X-ray detector of any example herein, particularly examples 20-21, wherein the direct X-ray detector has a sensitivity of at least 681 μC Gyₐᵢᵣ⁻¹cm⁻² at 5 V, of at least 1,352 μC Gyₐᵢᵣ⁻¹cm⁻² at 10 V, and of at least 2,292 μC Gyₐᵢᵣ⁻¹cm⁻² at 20 V.
Example 23: The direct X-ray detector of any example herein, particularly examples 20-22, wherein the direct X-ray detector has a limit of detection of 37.5 nGyₐᵢᵣs⁻¹ at 20V, wherein the limit of detection comprises a dose rate at a signal-to-noise ratio (SNR) of around 3.
Example 24: The direct X-ray detector of any example herein, particularly examples 20-23, wherein the direct X-ray detector exhibits stable performance at a total dosage of at least 15, 440 μGyₐᵢᵣ of X-ray at 20V over 24 hours.
Example 25: The direct X-ray detector of any example herein, particularly examples 20-24, wherein the direct X-ray detector exhibits stable X-ray-induced current when exposed to 178.7 μGyₐᵢᵣs⁻¹ dose rate applied at 20 second intervals for more than 580 continuous cycles.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The devices and methods of the appended claims are not limited in scope by the specific devices and methods described herein, which are intended as illustrations of a few aspects of the claims and any devices and methods that are functionally equivalent are intended to fall within the scope of the claims. Various modifications of the devices and methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A direct X-ray detector comprising an organic metal halide hybrid (OMHH) material and a first and a second electrode.

2. The direct X-ray detector of claim 1, wherein the OMHH has a composition of RₖMₗXₘ, wherein R is a semiconducting organic cation, M is a metal chosen from Zn, Cu, Mn, Pb, Sn, Sb, and Bi, and X is a halide chosen from Cl, Br, I, and combinations thereof, and wherein k, l, and m are integers.

3. The direct X-ray detector of claim 2, wherein the OMHH has a composition of (R)₂MX₄, (R)₂M₂X₄, or (R)₄M₄X₁₆.

4. The direct X-ray detector of claim 2, wherein the semiconducting organic cation of the OMHH is a charge transporter.

5. The direct X-ray detector of claim 1, wherein an organic moiety of the OMHH comprises a 4-(4-(diphenylamino) phenyl)-1-propylpyridin-1-ium (TPA-P⁺).

6. The direct X-ray detector of claim 1, wherein a metal halide of the OMHH is an X-ray absorber.

7. The direct X-ray detector of claim 1, wherein a metal halide of the OMHH comprises Zn, Cu, Bi, and a halide, wherein the halide is one of Br, Cl, I, or combinations thereof.

8. The direct X-ray detector of claim 1, wherein the OMHH material comprises (TPA-P)₂ZnX₄, (TPA-P)₂Cu₂X₄, or (TPA-P)₄Bi₄X₁₆.

9. The direct X-ray detector of claim 1, wherein the OMHH material comprises (TPA-P)₂ZnBr₄, (TPA-P)₂Zn₁₄, (TPA-P)₂Cu₂I₄, or (TPA-P)₄Bi₄I₁₆.

10. The direct X-ray detector of claim 1, wherein the OMHH material is zero-dimensional.

11. The direct X-ray detector of claim 1, wherein the OMHH material is a single crystal.

12. The direct X-ray detector of claim 1, wherein the OMHH material is produced by solution-based processing.

13. The direct X-ray detector of claim 1, wherein the OMHH material is produced by low-temperature processing.

14. The direct X-ray detector of claim 1, the first and the second electrode comprise Au, Ag, indium tin oxide (ITO), carbon nanotubes (CNT), Cu, Ni, Al, etc., or combinations thereof.

15. The direct X-ray detector of claim 1, wherein the direct X-ray detector has a working area of 0.8 by 0.8 mm².

16. The direct X-ray detector of claim 15, wherein the direct X-ray detector has a bias-dependent photoconductivity of 5.67×10⁻⁴ cm²·V⁻¹.

17. The direct X-ray detector of claim 15, wherein the direct X-ray detector has a sensitivity of at least 681 μC Gyₐᵢᵣ⁻¹cm⁻² at 5 V, of at least 1,352 μC Gyₐᵢᵣ⁻¹cm⁻² at 10 V, and of at least 2,292 μC Gyₐᵢᵣ⁻¹cm⁻² at 20 V.

18. The direct X-ray detector of claim 15, wherein the direct X-ray detector has a limit of detection of 37.5 nGyₐᵢᵣs⁻¹ at 20V, wherein the limit of detection comprises a dose rate at a signal-to-noise ratio (SNR) of around 3.

19. The direct X-ray detector of claim 15, wherein the direct X-ray detector exhibits stable performance at a total dosage of at least 15, 440 mGyₐᵢᵣ of X-ray at 20V over 24 hours.

20. The direct X-ray detector of claim 15, wherein the direct X-ray detector exhibits stable X-ray-induced current when exposed to 178.7 μGyₐᵢᵣs⁻¹ dose rate applied at 20 second intervals for more than 580 continuous cycles.
